(19) United States
(12) Patent Application Publication
(10) Pub. No.: US 2026/0203213 A1
(43) Pub. Date: Jul. 16, 2026

(54) Techniques For Deterministically Terminating A Phase Of Concurrent Operations

(71) Applicant: Oracle International Corporation, Redwood Shores, CA (US)

(72) Inventors: Erik Österlund, Vasterhaninge (SE); Axel Boldt-Christmas, Stockholm (SE); Stefan Mats Rikard Karlsson, Nacka (SE)

(73) Assignee: Oracle International Corporation, Redwood Shores, CA (US)

(21) Appl. No.: 19/021,827

(22) Filed: Jan. 15, 2025

(51) Int. Cl. G06F 12/02; G06F 9/30

(52) U.S. Cl. CPC G06F 12/0269; G06F 9/3009

(57) ABSTRACT

Techniques are disclosed for avoiding termination indeterminism associated with a phase of concurrent operations. For instance, during a concurrent marking phase of a garbage collection cycle, the system generates a first data structure to record reachability information of runtime objects in a memory area that are strongly reachable, and the system generates a second data structure to record reachability information of runtime objects that are reachable but not strongly reachable. In particular, the second data structure records reachability information of runtime objects that could become strongly reachable as a result of a potential resurrection. If the potential resurrection occurs during a termination procedure for the concurrent marking phase, the system takes note of the resurrection and proceeds with the termination procedure as normal. The system uses the second data structure to update the reachability information recorded by the first data structure after the termination procedure is completed.

### TECHNICAL FIELD

The present disclosure relates to phases of concurrent operations. In particular, the present disclosure relates to techniques for terminating a phase of concurrent operations.

### BACKGROUND

With respect to a computing architecture, the term “concurrency” refers to the ability of a computing system to perform multiple operations simultaneously and/or the ability of the computing system to perform multiple operations in overlapping time periods. Concurrency can improve the efficiency and performance of a computing system. However, concurrency can give rise to an issue that results from one operation interfering with another operation that is being performed at the same time (referred to as a “concurrency issue”). Examples of concurrency issues include termination indeterminism, race conditions, deadlock, livelock, starvation, and others.

In the field of computer science, the term “garbage collection” is used to refer to memory management. For example, a “garbage collection process” may refer to a process for reclaiming memory allocated to a program instance. Once memory allocated to a program instance has been reclaimed by a garbage collection process, that reclaimed memory may be reused by that program instance or another program instance.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example computing architecture in which techniques described herein may be practiced according to an embodiment;

FIG. 2 is a block diagram illustrating one embodiment of a computer system suitable for implementing methods and features described herein;

FIG. 3 illustrates an example virtual machine memory layout in block diagram form according to an embodiment;

FIG. 4 illustrates an example frame in block diagram form according to an embodiment;

FIG. 5 illustrates an example memory area in which techniques described herein may be practiced according to an embodiment;

FIG. 6 illustrates a garbage collection system according to an embodiment;

FIG. 7 illustrates a garbage collection cycle in block diagram form according to an embodiment;

FIG. 8 illustrates an example set of operations for generating records of state information according to an embodiment;

FIG. 9 illustrates an example set of operations for terminating a concurrent marking phase according to an embodiment;

FIG. 10 illustrates an example set of operations for updating records of state information according to an embodiment;

FIG. 11 illustrates an example memory area that may be marked through during a concurrent marking phase according to an example embodiment; and

FIG. 12 illustrates a computer system in block diagram form according to an embodiment.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

The following table of contents is provided for the reader's convenience and is not intended to define the limits of the disclosure.
1. GENERAL OVERVIEW
2. ARCHITECTURAL OVERVIEW
2.1 EXAMPLE CLASS FILE STRUCTURE
2.2 EXAMPLE VIRTUAL MACHINE ARCHITECTURE
2.3 LOADING, LINKING, & INITIALIZING
2.4 EXAMPLE MEMORY AREA
3. GARBAGE COLLECTION SYSTEM
4. GARBAGE COLLECTION CYCLE
5. DETERMINISTICALLY TERMINATING A PHASE OF CONCURRENT OPERATIONS
5.1 GENERATING RECORDS OF STATE INFORMATION
5.2 TERMINATING A CONCURRENT MARKING PHASE
5.3 UPDATING RECORDS OF STATE INFORMATION
6. EXAMPLE EMBODIMENT
7. HARDWARE OVERVIEW
8. MISCELLANEOUS; EXTENSIONS

### 1. General Overview

One or more embodiments deterministically terminate a concurrent marking phase of a garbage collection cycle targeting a memory area by precomputing the impact of a program instance mutating the memory area during a termination procedure for the concurrent marking phase. As used herein, the term “mutation” refers to an alteration to information stored in a memory area, and the term “mutator” refers to an execution environment (e.g., a thread of execution) that creates a mutation. A concurrent marking phase is a phase of a garbage collection cycle, and a concurrent marking phase is an example of a phase of concurrent operations. As used herein, the term “phase of concurrent operations” refers to a period of time in which multiple operations may be performed concurrently in the same computing environment. For instance, during an example concurrent marking phase, at least one garbage collector thread is marking through runtime objects residing in a memory area, while at least one program thread is concurrently manipulating runtime objects residing in the memory area. For purposes of brevity in explanation, a phase of concurrent operations may be referred to herein in short as a “concurrent phase.”

One or more embodiments avoid aborting an attempt to terminate a concurrent phase in a computing environment by precomputing the impact of a potential change to the computing environment's state that might occur during an attempt to terminate the concurrent phase. During the concurrent phase, the system performs operations in the computing environment while at least one program instance is concurrently executing in the computing environment. Any given operation that is performed in the computing environment at the behest of the system or the program instance may change (i.e., mutate) the computing environment's state. Throughout the concurrent phase, the system and a program instance are required to maintain a harmonious understanding of the computing environment's state. In addition, to successfully terminate the concurrent phase, the system and the program instance are required to agree on what the computing environment's state will be after the concurrent phase has concluded. However, note that a program instance is free to continue requesting mutations to the computing environment while the system is attempting to terminate the concurrent phase, and a mutation during the termination attempt might create a misunderstanding between the system and the program instance with regard to the computing environment's state. Thus, during the concurrent phase, the system generates data structures that effectively predict how potential mutations will impact the system's understanding of the computing environment's state. Having generated a data structure that predicts the impact of a potential mutation, the system avoids having to abort an attempt to terminate the concurrent phase if that potential mutation occurs during the termination attempt. Instead, the system simply takes note of the mutation and continues with the termination attempt as if no mutation has occurred. After the termination attempt has been successfully completed, the system updates the system's understanding of the computing environment's state based on the data structures that the system generated during the concurrent phase. In this way, the system can deterministically terminate the concurrent phase.

One or more embodiments are enabled to deterministically terminate a concurrent marking phase of a garbage collection cycle targeting a memory area by precomputing how the accessibility of runtime objects residing in the memory area will change in response to a potential mutation that might occur during a procedure for terminating the concurrent marking phase. The memory area serves as runtime memory for a program instance. During the concurrent marking phase, the system generates records of state information that describe the accessibility of the runtime objects residing in the memory area while the program instance is concurrently executing. Once the system has finished generating the records of state information, the system initiates a termination procedure for the concurrent marking phase. However, an execution environment for the program instance (e.g., a program thread) is free to continue manipulating runtime objects residing in the memory area while the system is performing the termination procedure. Note that manipulating a runtime object may alter the accessibility of that runtime object and/or other runtime objects, thereby rendering a record of state information inaccurate. Further note that an uncorrected inaccuracy in a record of state information could cause erroneous collections in subsequent phases of the garbage collection cycle. Thus, prior to initiating the termination procedure, the system generates data structures that effectively predict how the accessibility of runtime objects residing in the memory area will change in response to potential mutations that might occur during the termination procedure. Having generated a data structure that predicts how the accessibility of runtime objects residing in the memory area will change in response to a potential mutation, the system avoids having to abort a termination procedure for the concurrent phase if that potential mutation occurs during the termination procedure. Instead, the system simply takes note of the mutation and proceeds onward with the termination procedure as normal. After successfully terminating the concurrent marking phase, the system updates the records of state information using the data structures that the system generated during the concurrent marking phase.

One or more embodiments are enabled to deterministically terminate a concurrent marking phase of a garbage collection cycle that is targeting a memory area by enforcing a barrier on a program thread that attempts to mutate the memory area while a procedure for terminating the concurrent marking phase is ongoing. As used herein, a “barrier” refers to an additional set of machine-level instructions inserted into the machine-level code (e.g., the machine-level code of a program instance) that is being performed by an execution environment (e.g., a thread). During the termination procedure, the system attempts to gather program threads at a safe point where the program instance can be safely paused, and the concurrent marking phase can be terminated. However, note that a program thread continues to perform machine-level code of a program instance until the program thread arrives at a safe point. Thus, while the system is attempting to corral a program thread to the safe point, that program thread might mutate the memory area. To prevent a concurrency issue that might otherwise arise as a consequence of a mutation created by a program thread during a termination procedure, the system injects a barrier into the machine-level code that is being performed by the program thread. The barrier compels the program thread to generate a record of the mutation. Once the termination procedure is successfully completed, the system will use the record of the mutation to access a data structure that predicts the impact of that mutation, and the system will update records of state information based on the data structure.

One or more embodiments described in this Specification and/or recited in the claims may not be included in this General Overview section.

### 2. Architectural Overview

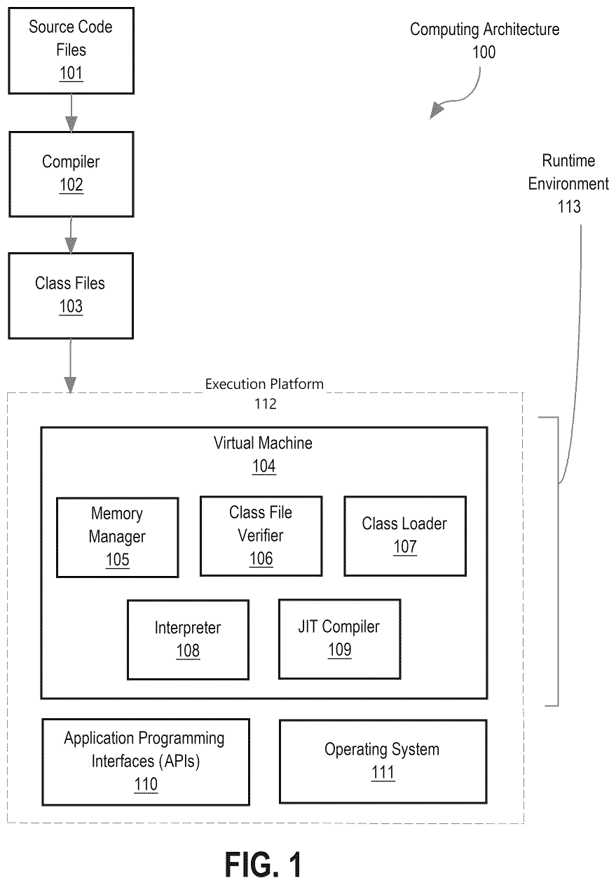

FIG. 1 illustrates an example architecture in which techniques described herein may be practiced. Software and/or hardware components described with relation to the example architecture may be omitted or associated with a different set of functionality than described herein. Software and/or hardware components, not described herein, may be used within an environment in accordance with one or more embodiments. Accordingly, the example environment should not be constructed as limiting the scope of any of the claims.

As illustrated in FIG. 1, a computing architecture 100 includes source code files 101 which are compiled by a compiler 102 into class files 103 representing the program to be executed. The class files 103 are then loaded and executed by an execution platform 112, which includes a runtime environment 113, an operating system 111, and one or more application programming interfaces (APIs) 110 that enable communication between the runtime environment 113 and the operating system 111. The runtime environment 113 includes a virtual machine 104 comprising various components, such as a memory manager 105 (which may include a garbage collector), a class file verifier 106 to check the validity of class files 103, a class loader 107 to locate and build in-memory representations of classes, an interpreter 108 for executing the virtual machine 104 code, and a just-in-time (JIT) compiler 109 for producing optimized machine-level code.

In an embodiment, the computing architecture 100 includes source code files 101 that contain code that has been written in a particular programming language, such as Java, C, C++, C #, Ruby, Perl, etc. Thus, the source code files 101 adhere to a particular set of syntactic and/or semantic rules for the associated language. For example, code written in Java adheres to the Java Language Specification. However, since specifications are updated and revised over time, the source code files 101 may be associated with a version number indicating the revision of the specification to which the source code files 101 adhere. The exact programming language used to write the source code files 101 is generally not critical.

In various embodiments, the compiler 102 converts the source code, which is written according to a specification directed to the convenience of the programmer, to either machine or object code, which is executable directly by the particular machine environment, or an intermediate representation (“virtual machine code/instructions”), such as bytecode, which is executable by a virtual machine 104 that is capable of running on top of a variety of particular machine environments. The virtual machine instructions are executable by the virtual machine 104 in a more direct and efficient manner than the source code. Converting source code to virtual machine instructions includes mapping source code functionality from the language to virtual machine functionality that utilizes underlying resources, such as data structures. Often, functionality that is presented in simple terms via source code by the programmer is converted into more complex steps that map more directly to the instruction set supported by the underlying hardware on which the virtual machine 104 resides.

In general, programs are executed either as a compiled or an interpreted program. When a program is compiled, the code is transformed globally from a first language to a second language before execution. Since the work of transforming the code is performed ahead of time; compiled code tends to have excellent run-time performance. In addition, since the transformation occurs globally before execution, the code can be analyzed and optimized using techniques such as constant folding, dead code elimination, inlining, etc. However, depending on the program being executed, the startup time can be significant. In addition, inserting new code would require the program to be taken offline, re-compiled, and re-executed. For many dynamic languages (such as Java) which are designed to allow code to be inserted during the program's execution, a purely compiled approach may be inappropriate. When a program is interpreted, the code of the program is read line-by-line and converted to machine level instructions while the program is executing. As a result, the program has a short startup time (can begin executing almost immediately), but the run-time performance is diminished by performing the transformation at runtime. Furthermore, since various instructions are analyzed individually, many optimizations that rely on a more global analysis of the program cannot be performed.

In some embodiments, the virtual machine 104 includes an interpreter 108 and a JIT compiler 109 (or a component implementing aspects of both), and executes programs using a combination of interpreted and compiled techniques. For example, the virtual machine 104 may initially begin by interpreting the virtual machine instructions representing the program via the interpreter 108 while tracking statistics related to program behavior, such as how often different sections or blocks of code are executed by the virtual machine 104. Once a block of code surpasses a threshold (is “hot”), the virtual machine 104 invokes the JIT compiler 109 to perform an analysis of the block and generate optimized machine-level instructions which replaces the “hot” block of code for future executions. Since programs tend to spend most time executing a small portion of overall code, compiling just the “hot” portions of the program can provide similar performance to fully compiled code, but without the start-up penalty. Furthermore, although the optimization analysis is constrained to the “hot” block being replaced, there still exists far greater optimization potential than converting instructions individually. There are several variations on the above described example, such as tiered compiling.

In order to provide clear examples, the source code files 101 have been illustrated as the “top level” representation of the program to be executed by the execution platform 112. Although the computing architecture 100 depicts the source code files 101 as a “top level” program representation, in other embodiments the source code files 101 may be an intermediate representation received via a “higher level” compiler that processed code files in a different language into the language of the source code files 101. Some examples in the following disclosure assume that the source code files 101 adhere to a class-based object-oriented programming language. However, this is not a requirement to utilizing the features described herein.

In an embodiment, compiler 102 receives as input the source code files 101 and converts the source code files 101 into class files 103 that are in a format expected by the virtual machine 104. For example, in the context of the JVM, the Java Virtual Machine Specification defines a particular class file format to which the class files 103 are expected to adhere. In some embodiments, the class files 103 contain the virtual machine instructions that have been converted from the source code files 101. However, in other embodiments, the class files 103 may contain other structures as well, such as tables identifying constant values and/or metadata related to various structures (classes, fields, methods, etc.).

The following discussion assumes that the class files 103 represents a respective “class” defined in the source code files 101 (or dynamically generated by the compiler 102/virtual machine 104). However, the aforementioned assumption is not a strict requirement and will depend on the implementation of the virtual machine 104. Thus, the techniques described herein may still be performed regardless of the exact format of the class files 103. In some embodiments, the class files 103 are divided into one or more “libraries” or “packages”, each of which includes a collection of classes that provide related functionality. For example, a library may contain one or more class files that implement input/output (I/O) operations, mathematics tools, cryptographic techniques, graphics utilities, etc. Further, some classes (or fields/methods within those classes) may include access restrictions that limit their use to within a particular class/library/package or to classes with appropriate permissions.

### 2.1 Example Class File Structure

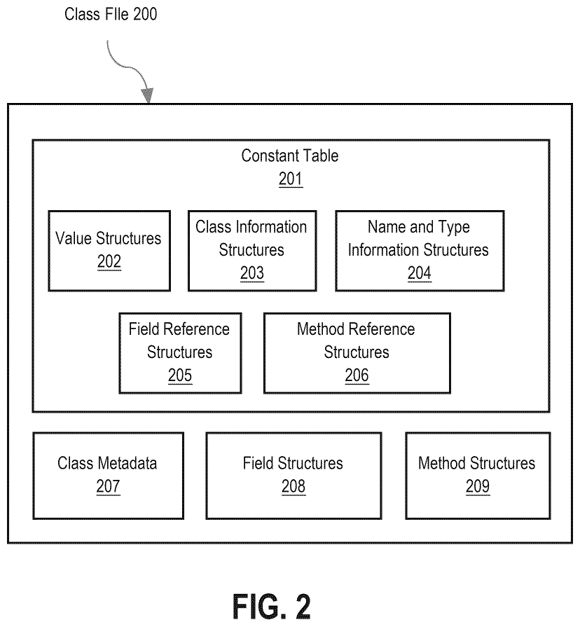

FIG. 2 illustrates an example structure for a class file 200 in block diagram form according to an embodiment. In order to provide clear examples, the remainder of the disclosure assumes that the class files 103 of the computing architecture 100 adhere to the structure of the example class file 200 described in this section. However, in a practical environment, the structure of the class file 200 will be dependent on the implementation of the virtual machine 104. Further, one or more features discussed herein may modify the structure of the class file 200 to, for example, add additional structure types. Therefore, the exact structure of the class file 200 is not critical to the techniques described herein. For the purposes of Section 2.1, “the class” or “the present class” refers to the class represented by the class file 200.

In FIG. 2, the class file 200 includes a constant table 201, class metadata 207, field structures 208, and method structures 209. In an embodiment, the constant table 201 is a data structure which, among other functions, acts as a symbol table for the class. For example, the constant table 201 may store data related to the various identifiers used in the source code files 101 such as type, scope, contents, and/or location. The constant table 201 has entries for value structures 202 (representing constant values of type int, long, double, float, byte, string, etc.), class information structures 203, name and type information structures 204, field reference structures 205, and method reference structures 206 derived from the source code files 101 by the compiler 102. In an embodiment, the constant table 201 is implemented as an array that maps an index i to structure j. However, the exact implementation of the constant table 201 is not critical.

In some embodiments, the entries of the constant table 201 include structures which index other constant table 201 entries. For example, an entry for one of the value structures 202 representing a string may hold a tag identifying its “type” as string and an index to one or more other value structures 202 of the constant table 201 storing char, byte or int values representing the ASCII characters of the string.

In an embodiment, field reference structures 205 of the constant table 201 hold an index into the constant table 201 to one of the class information structures 203 representing the class defining the field and an index into the constant table 201 to one of the name and type information structures 204 that provides the name and descriptor of the field. Method reference structures 206 of the constant table 201 hold an index into the constant table 201 to one of the class information structures 203 representing the class defining the method and an index into the constant table 201 to one of the name and type information structures 204 that provides the name and descriptor for the method. The class information structures 203 hold an index into the constant table 201 to one of the value structures 202 holding the name of the associated class.

The name and type information structures 204 hold an index into the constant table 201 to one of the value structures 202 storing the name of the field/method and an index into the constant table 201 to one of the value structures 202 storing the descriptor.

In an embodiment, class metadata 207 includes metadata for the class, such as version number(s), number of entries in the constant pool, number of fields, number of methods, access flags (if the class is public, private, final, abstract, etc.), an index to one of the class information structures 203 of the constant table 201 that identifies the present class, an index to one of the class information structures 203 of the constant table 201 that identifies the superclass (if any), etc.

In an embodiment, the field structures 208 represent a set of structures that identifies the various fields of the class. The field structures 208 store, for a field of the class, accessor flags for the field (if the field is static, public, private, final, etc.), an index into the constant table 201 to one of the value structures 202 that holds the name of the field, and an index into the constant table 201 to one of the value structures 202 that holds a descriptor of the field.

In an embodiment, the method structures 209 represent a set of structures that identifies the various methods of the class. The method structures 209 store, for a method of the class, accessor flags for the method (e.g. if the method is static, public, private, synchronized, etc.), an index into the constant table 201 to one of the value structures 202 that holds the name of the method, an index into the constant table 201 to one of the value structures 202 that holds the descriptor of the method, and the virtual machine instructions that correspond to the body of the method as defined in the source code files 101.

In an embodiment, a descriptor represents a type of a field or method. For example, the descriptor may be implemented as a string adhering to a particular syntax. While the exact syntax is not critical, a few examples are described below.

In an example where the descriptor represents a type of the field, the descriptor identifies the type of data held by the field. In an embodiment, a field can hold a basic type, an object, or an array. When a field holds a basic type, the descriptor is a string that identifies the basic type (e.g., “B”= byte, “C”=char, “D”=double, “F”=float, “I”=int, “J”=long int, etc.). When a field holds an object, the descriptor is a string that identifies the class name of the object (e.g. “L ClassName”). “L” in this case indicates a reference, thus “L ClassName” represents a reference to an object of class ClassName. When the field is an array, the descriptor identifies the type held by the array. For example, “[B” indicates an array of bytes, with “[” indicating an array and “B” indicating that the array holds the basic type of byte. However, since arrays can be nested, the descriptor for an array may also indicate the nesting. For example, “[[L ClassName” indicates an array where an index holds an array that holds objects of class ClassName. In some embodiments, the ClassName is fully qualified and includes the simple name of the class, as well as the pathname of the class. For example, the ClassName may indicate where the file is stored in the package, library, or file system hosting the class file 200.

In the case of a method, the descriptor identifies the parameters of the method and the return type of the method. For example, a method descriptor may follow the general form “({ParameterDescriptor}) ReturnDescriptor”, where the {ParameterDescriptor} is a list of field descriptors representing the parameters and the ReturnDescriptor is a field descriptor identifying the return type. For instance, the string “V” may be used to represent the void return type. Thus, a method defined in the source code files 101 as “Object m(int I, double d, Thread t) { . . . }” matches the descriptor “(I D L Thread) L Object”.

In an embodiment, the virtual machine instructions held in the method structures 209 include operations which reference entries of the constant table 201. Using Java as an example, consider the following class:
class A
{
   int add12and13( ) {
      return B. addTwo (12, 13);
   }
}

In the above example, the Java method add12and13 is defined in class A, takes no parameters, and returns an integer. The body of method add12and13 calls static method addTwo of class B which takes the constant integer values 12 and 13 as parameters, and returns the result. Thus, in the constant table 201, the compiler 102 includes, among other entries, a method reference structure that corresponds to the call to the method B.addTwo. In Java, a call to a method compiles down to an invoke command in the bytecode of the JVM (in this case invokestatic as addTwo is a static method of class B). The invoke command is provided an index into the constant table 201 corresponding to the method reference structure that identifies the class defining addTwo “B”, the name of addTwo “addTwo”, and the descriptor of addTwo “(I I)I”. For example, assuming the aforementioned method reference is stored at index 4, the bytecode instruction may appear as “invokestatic #4”.

Since the constant table 201 refers to classes, methods, and fields symbolically with structures carrying identifying information, rather than direct references to a memory location, the entries of the constant table 201 are referred to as “symbolic references”. One reason that symbolic references are utilized for the class files 103 is because, in some embodiments, the compiler 102 is unaware of how and where the classes will be stored once loaded into the runtime environment 113. As will be described in Section 2.3, eventually the run-time representations of the symbolic references are resolved into actual memory addresses by the virtual machine 104 after the referenced classes (and associated structures) have been loaded into the runtime environment and allocated concrete memory locations.

### 2.2 Example Virtual Machine Architecture

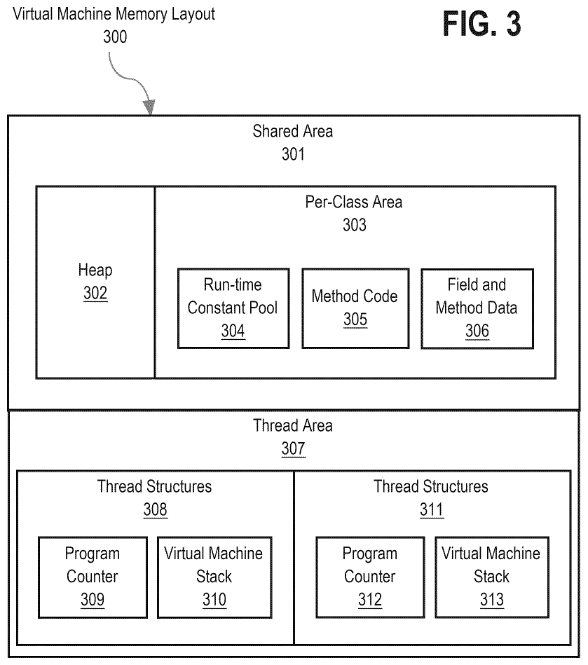

FIG. 3 illustrates an example virtual machine memory layout 300 in block diagram form according to an embodiment. In order to provide clear examples, the remaining discussion will assume that the virtual machine 104 adheres to the virtual machine memory layout 300 depicted in FIG. 3. In addition, although components of the virtual machine memory layout 300 may be referred to as memory “areas”, there is no requirement that the memory areas are contiguous.

In the example illustrated by FIG. 3, the virtual machine memory layout 300 is divided into a shared area 301 and a thread area 307. The shared area 301 represents an area in memory where structures shared among the various threads executing on the virtual machine 104 are stored. The shared area 301 includes a heap 302 and a per-class area 303. In an embodiment, the heap 302 represents the run-time data area from which memory for class instances and arrays is allocated. In an embodiment, the per class area 303 represents the memory area where the data pertaining to the individual classes are stored. In an embodiment, the per-class area 303 includes, for a loaded class, a run-time constant pool 304 representing data from the constant table 201 of the class, field and method data 306 (for example, to hold the static fields of the class), and the method code 305 representing the virtual machine instructions for methods of the class.

The thread area 307 represents a memory area where structures specific to individual threads are stored. In FIG. 3, the thread area 307 includes thread structures 308 and thread structures 311, representing the per-thread structures utilized by different threads. In order to provide clear examples, the thread area 307 depicted in FIG. 3 assumes two threads are executing on the virtual machine 104. However, in a practical environment, the virtual machine 104 may execute any arbitrary number of threads, with the number of thread structures scaled accordingly.

In an embodiment, thread structures 308 includes program counter 309 and virtual machine stack 310. Similarly, thread structures 311 includes program counter 312 and virtual machine stack 313. In an embodiment, program counter 309 and program counter 312 store the current address of the virtual machine instruction being executed by their respective threads.

Thus, as a thread steps through the instructions, the program counters are updated to maintain an index to the current instruction. In an embodiment, virtual machine stack 310 and virtual machine stack 313 store frames for their respective threads that hold local variables and partial results, and is also used for method invocation and return.

In an embodiment, a frame is a data structure used to store data and partial results, return values for methods, and perform dynamic linking. A new frame is created each time a method is invoked. A frame is destroyed when the method that caused the frame to be generated completes. Thus, when a thread performs a method invocation, the virtual machine 104 generates a new frame and pushes that frame onto the virtual machine stack associated with the thread.

When the method invocation completes, the virtual machine 104 passes back the result of the method invocation to the previous frame and pops the current frame off of the stack. In an embodiment, for a given thread, one frame is active at any point. This active frame is referred to as the current frame, the method that caused generation of the current frame is referred to as the current method, and the class to which the current method belongs is referred to as the current class.

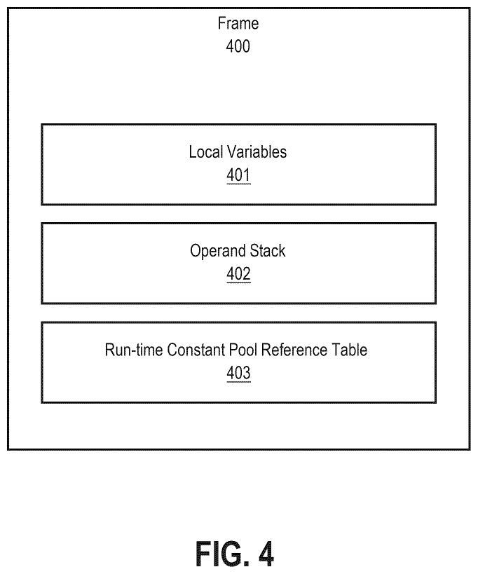

FIG. 4 illustrates an example frame 400 in block diagram form according to an embodiment. In order to provide clear examples, the remaining discussion will assume that frames of virtual machine stack 310 and virtual machine stack 313 adhere to the structure of frame 400.

In an embodiment, frame 400 includes local variables 401, operand stack 402, and run-time constant pool reference table 403. In an embodiment, the local variables 401 are represented as an array of variables that each hold a value, for example, Boolean, byte, char, short, int, float, or reference. Further, some value types, such as longs or doubles, may be represented by more than one entry in the array. The local variables 401 are used to pass parameters on method invocations and store partial results. For example, when generating the frame 400 in response to invoking a method, the parameters may be stored in predefined positions within the local variables 401, such as indexes 1-N corresponding to the first to Nth parameters in the invocation.

In an embodiment, when the frame 400 is created by the virtual machine 104, the operand stack 402 is empty by default. The virtual machine 104 then supplies instructions from the method code 305 of the current method to load constants or values from the local variables 401 onto the operand stack 402. Other instructions take operands from the operand stack 402, operate on them, and push the result back onto the operand stack 402. Furthermore, the operand stack 402 is used to prepare parameters to be passed to methods and to receive method results. For example, the parameters of the method being invoked could be pushed onto the operand stack 402 prior to issuing the invocation to the method. The virtual machine 104 then generates a new frame for the method invocation where the operands on the operand stack 402 of the previous frame are popped and loaded into the local variables 401 of the new frame. When the invoked method terminates, the new frame is popped from the virtual machine stack and the return value is pushed onto the operand stack 402 of the previous frame.

In an embodiment, the run-time constant pool reference table 403 contains a reference to the run-time constant pool 304 of the current class. The run-time constant pool reference table 403 is used to support resolution. Resolution is the process whereby symbolic references in the constant pool 304 are translated into concrete memory addresses, loading classes as necessary to resolve as-yet-undefined symbols and translating variable accesses into appropriate offsets into storage structures associated with the run-time location of these variables.

### 2.3 Loading, Linking, & Initializing

In an embodiment, the virtual machine 104 dynamically loads, links, and initializes classes. Loading is the process of finding a class with a particular name and creating a representation from the associated class file 200 of that class within the memory of the runtime environment 113. For example, creating the representation from the associated class file 200 may include creating the run-time constant pool 304, method code 305, and field and method data 306 for the class within the per-class area 303 of the virtual machine memory layout 300. Linking is the process of taking the in-memory representation of the class and combining it with the run-time state of the virtual machine 104 so that the methods of the class can be executed. Initialization is the process of executing the class constructors to set the starting state of the field and method data 306 of the class and/or create class instances on the heap 302 for the initialized class.

The following are examples of loading, linking, and initializing techniques that may be implemented by the virtual machine 104. However, in many embodiments the steps may be interleaved, such that an initial class is loaded, then during linking a second class is loaded to resolve a symbolic reference found in the first class, which in turn causes a third class to be loaded, etc. Thus, progress through the stages of loading, linking, and initializing can differ from class to class. Furthermore, some embodiments may delay (perform “lazily”) one or more functions of the loading, linking, and initializing process until the class is required. For example, resolution of a method reference may be delayed until a virtual machine instruction invoking the method is executed. Thus, the exact timing of when the steps are performed for each class can vary greatly between implementations.

To begin the loading process, the virtual machine 104 invokes the class loader 107 which loads an initial class. The technique by which the initial class is specified will vary from embodiment to embodiment. For example, one technique may have the virtual machine 104 accept a command line argument on startup that specifies the initial class.

To load a class, the class loader 107 parses the class file 200 corresponding to the class and determines if the class file 200 is well-formed (meets the syntactic expectations of the virtual machine 104). If not, the class loader 107 generates an error. For example, in Java the error might be generated in the form of an exception which is thrown to an exception handler for processing. Otherwise, the class loader 107 generates the in-memory representation of the class by allocating the run-time constant pool 304, method code 305, and field and method data 306 for the class within the per-class area 303.

In some embodiments, when the class loader 107 loads a class, the class loader 107 also recursively loads the super-classes of the loaded class. For example, the virtual machine 104 may ensure that the super-classes of a particular class are loaded, linked, and/or initialized before proceeding with the loading, linking and initializing process for the particular class.

During linking, the virtual machine 104 verifies the class, prepares the class, and resolves the symbolic references defined in the run-time constant pool 304 of the class.

To verify the class, the virtual machine 104 checks if the in-memory representation of the class is structurally correct. For example, the virtual machine 104 may check that each class except the generic class Object has a superclass, check that final classes have no sub-classes and final methods are not overridden, check if constant pool entries are consistent with one another, check if the current class has correct access permissions for classes/fields/structures referenced in the constant pool 304, check that the virtual machine 104 code of methods will not cause unexpected behavior (e.g. making sure a jump instruction does not send the virtual machine 104 beyond the end of the method), etc. The exact checks performed during verification are dependent on the implementation of the virtual machine 104. In some cases, verification may cause additional classes to be loaded, but does not necessarily require those classes to also be linked before proceeding. For example, assume Class A contains a reference to a static field of Class B. During verification, the virtual machine 104 may check Class B to ensure that the referenced static field actually exists, which might cause loading of Class B, but not necessarily the linking or initializing of Class B. However, in some embodiments, certain verification checks can be delayed until a later phase, such as being checked during resolution of the symbolic references. For example, some embodiments may delay checking the access permissions for symbolic references until those references are being resolved.

To prepare a class, the virtual machine 104 initializes static fields located within the field and method data 306 for the class to default values. In some cases, setting the static fields to default values may not be the same as running a constructor for the class. For example, the verification process may zero out or set the static fields to values that the constructor would expect those fields to have during initialization.

During resolution, the virtual machine 104 dynamically determines concrete memory address from the symbolic references included in the run-time constant pool 304 of the class. To resolve the symbolic references, the virtual machine 104 utilizes the class loader 107 to load the class identified in the symbolic reference (if not already loaded). Once loaded, the virtual machine 104 has knowledge of the memory location within the per-class area 303 of the referenced class and its fields/methods. The virtual machine 104 then replaces the symbolic references with a reference to the concrete memory location of the referenced class, field, or method. In an embodiment, the virtual machine 104 caches resolutions to be reused in case the same class/name/descriptor is encountered when the virtual machine 104 processes another class. For example, in some cases, class A and class B may invoke the same method of class C. Thus, when resolution is performed for class A, that result can be cached and reused during resolution of the same symbolic reference in class B to reduce overhead.

In some embodiments, the step of resolving the symbolic references during linking is optional. For example, an embodiment may perform the symbolic resolution in a “lazy” fashion, delaying the step of resolution until a virtual machine instruction that requires the referenced class/method/field is executed.

During initialization, the virtual machine 104 executes the constructor of the class to set the starting state of that class. For example, initialization may initialize the field and method data 306 for the class and generate/initialize any class instances on the heap 302 created by the constructor. For example, the class file 200 for a class may specify that a particular method is a constructor that is used for setting up the starting state. Thus, during initialization, the virtual machine 104 executes the instructions of that constructor.

In some embodiments, the virtual machine 104 performs resolution on field and method references by initially checking if the field/method is defined in the referenced class. Otherwise, the virtual machine 104 recursively searches through the super-classes of the referenced class for the referenced field/method until the field/method is located, or the top-level superclass is reached, in which case an error is generated.

### 2.4 Example Memory Area

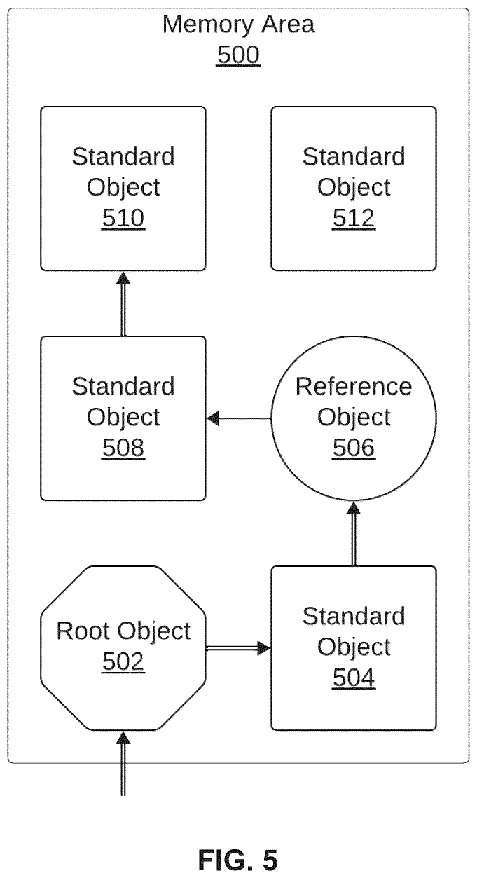

FIG. 5 illustrates an example memory area 500 in which techniques described herein may be practiced in accordance with one or more embodiments. A detailed example is described in this Section 2.4 for purpose of clarity and understanding. Components and/or operations described below should be understood as one specific example that may not be applicable to certain embodiments. Accordingly, components and/or operations described below should not be construed as limiting the scope of any of the claims.

In an embodiment, a memory area 500 is allocated for storing runtime objects associated with one or more program instances. The runtime objects residing in memory area 500 are instantiations of reference types (e.g., classes). One runtime object residing in memory area 500 may refer to another runtime object residing in memory area 500 by possessing an object field that holds a reference to the other runtime object. Runtime objects are represented in FIG. 5 as enclosed planar shapes (e.g., a circle, a square, a hexagon, etc.). References to runtime objects residing in memory area 500 are represented in FIG. 5 as arrows. A conceptualization of runtime objects that are linked together by references between the runtime objects (e.g., as depicted in FIG. 5) may be referred to herein as an “object graph.” Note that (a) the example illustrated by FIG. 5 is limited to depicting references and runtime objects residing in memory area 500 that are exposed at a program level and (b) FIG. 5 does not depict any references or runtime objects residing in memory area 500 that are not exposed at a program level. To provide clear examples, the remainder of the discussion in this Section 2.4 with reference to FIG. 5 assumes that memory area 500 includes no runtime objects or references that are exposed at a program level other than those runtime objects and references that are illustrated in FIG. 5.

In an embodiment, a memory area 500 includes root object(s). As used herein, the term “root object” refers to a runtime object that is referred to by a root, and the term “root” identifies a reference to a runtime object that may serve as an entry point to a memory area that the runtime object resides in. In the example illustrated by FIG. 5, memory area 500 includes a single root object 502. However, it should be understood that a memory area 500 can (and often does) include multiple root objects. Note that the root that refers to runtime object 502 does not originate from any other runtime object within memory area 500. Instead, the root originates from somewhere outside of memory area 500. For example, the root that is pointing to root object 502 may be held by a stack variable, a global variable, a static variable, a local variable, or another data structure outside of memory area 500.

In an embodiment, a memory area 500 includes standard object(s). As used herein, the term “standard object” refers to a runtime object that is neither a root object nor a reference object. In the example illustrated by FIG. 5, memory area 500 includes standard object 504, standard object 508, standard object 510, and standard object 512.

In an embodiment, a memory area 500 includes reference object(s). A reference object is a special type of runtime object that is used to indirectly refer to another runtime object. A runtime object that a reference object is used to refer to is identified as the reference object's “referent.” Examples of reference objects include soft reference objects, weak reference objects, final reference objects, phantom reference objects, and others. Note that, unlike other example reference objects, a final reference object is not exposed at the program level. In the example illustrated by FIG. 5, memory area 500 includes reference object 506, and standard object 508 is the referent of reference object 506. Standard object 504 indirectly refers to standard object 508 through reference object 506.

It should be noted that reference objects are often referred to colloquially as “references” rather than “objects.” For example, a soft reference object is often referred to as a “soft reference,” a weak reference object is often referred to as a “weak reference,” a final reference object is often referred to as a “final reference,” and a phantom reference object is often referred to as a “phantom reference.” However, for the purposes of clarity and understanding, reference objects are not intentionally referred to herein as references rather than objects. Instead, as used herein, the term “soft reference” identifies a reference that links a soft reference object to the soft reference object's referent, the term “weak reference” identifies a reference that links a weak reference object to the weak reference object's referent, the term “final reference” identifies a reference that links a final reference object to the final reference object's referent, and the term “phantom reference” identifies a reference that links a phantom reference object to the phantom reference object's referent. For instance, in the example context of FIG. 5, if reference object 506 is a soft reference object, the reference that links reference object 506 to standard object 508 (i.e., the referent of reference object 506) may be referred to as a “soft reference.”

In an embodiment, a memory area 500 includes dereferenceable reference object(s), and/or the memory area 500 includes non-dereferenceable reference object(s). As used herein, a “dereferenceable reference object” refers to a reference object that (a) is exposed at a program level and (b) can be leveraged by a program instance to access the reference object's referent. A reference object typically will declare a get( ) method, and a program instance may attempt to dereference that reference object by calling the get( ) method. In the example illustrated by FIG. 5, reference object 506 is a dereferenceable reference object, or reference object 506 is a non-dereferenceable reference object. If reference object 506 is dereferenceable, then standard object 508 and standard object 510 are accessible to a program instance; however, if reference object 506 is non-dereferenceable, then standard object 508 and standard object 510 are not accessible to a program instance. Reference object 506 is dereferenceable if (a) reference object 506 is a weak reference object or a soft reference object, and (b) reference object 506 has not been cleared. Note that, in this scenario, calling the get( ) method will return the referent of reference object 506 (i.e., standard object 508). In contrast, if reference object 506 has been cleared, reference object 506 is non-dereferenceable, and calling the get( ) method of reference object 506 will return null. Alternatively, if reference object 506 is a phantom refence object, reference object 506 is non-dereferenceable starting from the moment reference object 506 is instantiated. Phantom reference objects also possess a get( ) method; however, a get( ) method offered by a phantom reference object is generally configured to return null starting from the moment the phantom reference object is instantiated. Thus, phantom reference objects are generally non-dereferenceable. However, note that while a get( ) method of a phantom reference object is often configured to return null, a get( ) method of a phantom reference object can be configured to return the phantom reference object's referent. Accordingly, in some cases, a phantom reference object may be dereferenceable. Final reference objects are not exposed at a program level; therefore, final reference objects are also non-dereferenceable. Note that above discussion in this paragraph refers generally to the behavior of standard soft reference objects, standard weak reference objects, standard final reference objects, and standard phantom reference objects. The behavior of a modified reference object (e.g., a modified soft reference object) or a custom reference object may differ.

In an embodiment, a memory area 500 includes non-strong reference(s), and/or memory area 500 includes strong reference(s). A “non-strong reference” is the special type of reference that is created by a reference object. In particular, a non-strong reference is the reference that links a reference object to the reference object's referent. The non-strong reference that is created by a reference object is held by an object field of the reference object known as the “referent field.” References other than non-strong references are identified as “strong references.” Strong references are “strong” in the sense that a strong reference to a runtime object may prevent that runtime object from being collected by a garbage collection process in some circumstances. Note that strong references are presented in FIG. 5 as double-lined arrows (e.g., ⇒), and non-strong references are represented in FIG. 5 as single-lined arrows. As used herein, a runtime object that holds a strong reference to another runtime object is said to “strongly refer” to the other runtime object, a soft reference object is said to “softly refer” to the soft reference object's referent, and a weak reference object is said to “weakly refer” to the weak reference object's referent.

In an embodiment, a memory area 500 includes reachable runtime object(s), and/or memory area 500 includes unreachable runtime object(s). Examples of a reachable runtime object include a strongly reachable object, a softly reachable object, a weakly reachable object, a finalizably reachable object, a phantom reachable object, and others. Note that the term “reachable” does not necessarily imply that a runtime object is accessible to a program instance. In the example illustrated by FIG. 5, root object 502, standard object 504, reference object 506, and standard object 508 are reachable. If reference object 506 is a phantom reference object, standard object 510 is unreachable; otherwise, standard object 510 is reachable in some manner. Standard object 512 is inaccessible to a program instance; however, standard object 512 is not necessarily unreachable. For instance, standard object 512 might be finalizably reachable. Recall that (a) FIG. 5 is limited to depicting references and runtime objects that are exposed at a program level, and (b) final references are not exposed at a program level.

In an embodiment, a memory area 500 includes strongly reachable runtime object(s). As used herein, a runtime object is considered “strongly reachable” if that runtime object can be accessed without having to traverse any reference object. In effect, root objects are strongly reachable, and a runtime object other than a root object (e.g., a standard object or a reference object) is strongly reachable if the runtime object is accessible through a chain of strong reference(s) that link the runtime object to a root object. In the example illustrated by FIG. 5, root object 502, standard object 504, and reference object 506 are strongly reachable. As used herein, the term “strong object graph” refers a network of strongly reachable runtime objects. For example, the term “strong object graph” with respect to FIG. 5 collectively refers to root object 502, standard object 504, reference object 506, and the interleaving strong references between those runtime objects.

In an embodiment, a memory area 500 includes softly reachable runtime object(s). As used herein, a runtime object is “softly reachable” if the runtime object (a) is not strongly reachable and (b) is accessible by traversing at least one reference object without having to traverse any weak reference object, final reference object, or phantom reference object. In effect, a runtime object is softly reachable if (a) the runtime object is reachable through a chain of reference(s) that links the runtime object to a root object, (b) the chain of reference(s) includes at least one soft reference, (c) the chain of reference(s) does not include a weak reference, and (d) the runtime object is not strongly reachable. In the example illustrated by FIG. 5, if reference object 506 is a soft reference object, then standard object 508 and standard object 510 are softly reachable. Note that, in this scenario, standard object 510 is softly reachable despite the fact that (a) standard object 510 is not a referent of a soft reference object, and (b) standard object 508 strongly refers to standard object 510.

In an embodiment, a memory area 500 includes weakly reachable runtime object(s). As used herein, a runtime object is referred to as “weakly reachable” if (a) the runtime object is accessible through a weak reference, and (b) the runtime object is neither strongly reachable nor softly reachable. In effect, a runtime object is weakly reachable if (a) the runtime object is accessible through a chain of reference(s) that links the runtime object to a root object, (b) the chain of reference(s) includes at least one weak reference, and (c) the runtime object is neither strongly reachable nor softly reachable. In the example depicted by FIG. 5, if reference object 506 is a weak reference object, then standard object 508 and standard object 510 are weakly reachable.

In an embodiment, a memory area 500 includes finalizably reachable runtime object(s). As used herein, a runtime object is referred to as “finalizably reachable” if the runtime object (a) is neither strongly reachable, softly reachable, nor weakly reachable and (b) is accessible through a chain of reference(s) that includes a final reference. Recall that final reference objects are non-dereferenceable. Therefore, the term “finalizably reachable” is somewhat of a misnomer in the sense that a finalizably “reachable” object is generally inaccessible to a program instance. However, note that a finalizably reachable object is accessible to a garbage collection process. For example, in the context of a multi-thread computing environment, a finalizably reachable runtime object is accessible to a thread that is responsible for executing finalizer methods (referred to as a “finalizer thread”). In an example implementation of memory area 500, a final reference object is instantiated when a finalizable object is instantiated, and the finalizable object is set as the referent of the final reference object. As used herein, a “finalizable object” is a runtime object that possess a defined finalizer method. An instance of a subclass that overrides a finalizer method of a super class (e.g., the finalizer method of the Java Object class) is one example of a finalizable object. A finalizable object may become finalizably reachable through a corresponding final reference object after the finalizable object becomes unreachable through other references. In the example illustrated by FIG. 5, standard object 512 may be finalizably reachable or may become finalizably reachable if standard object 512 is a finalizable object. However, it should also be noted that (a) a finalizably reachable object is not necessarily a finalizable object, and (b) a finalizably reachable object is not necessarily a referent of a final reference object. As an example, consider a referent of a final reference object (i.e., a finalizable object), and assume that the referent is finalizably reachable. In this example, if (a) the referent refers to another runtime object and (b) the other runtime object is not reachable through any other reference, the other runtime object is also finalizably reachable.

In an embodiment, a memory area 500 includes phantom reachable runtime object(s). As used herein, a runtime object is referred to as “phantom reachable” if (a) the runtime object is neither strongly reachable, softly reachable, weakly reachable, nor finalizably reachable, (b) any finalizer associated with the runtime object has already been called, and (c) the runtime object is reachable through one or more phantom references. In general, a phantom reachable object is a runtime object that has been finalized but not yet reclaimed by a garbage collection process. Recall that a phantom reference object is non-dereferenceable. Therefore, the term “phantom reachable” is also somewhat of a misnomer because a phantom “reachable” object is generally not accessible to a program instance. A phantom reachable object is generally not accessible to a program instance because a get method offered by a phantom reference object is typically configured to return null. In the example illustrated by FIG. 5, if reference object 506 is a phantom reference object, and if neither standard object 508 nor standard object 510 are finalizably reachable, then standard object 508 and standard object 510 are phantom reachable.

As used herein, the term “reachability status” refers generally to whether a runtime object is considered strongly reachable, softly reachable, weakly reachable, finalizably reachable, phantom reachable, or unreachable. Note that a runtime object's reachability status corresponds to the strongest form of reachability that the runtime object possesses. As an example, assume that a runtime object is strongly reachable through one chain of references, and further assume that the runtime object is softly reachable through another chain of references. In this example, the runtime object's is considered strongly reachable rather than softly reachable. The relative strength of reachability statuses, from strongest to weakest, is (a) strongly reachable, (b) softly reachable, (c) weakly reachable, (d) finalizably reachable, and (e) phantom reachable. Note that the reference objects described in this Section 2.4 do not represent an exhaustive list of reference objects. For instance, another example of a reference object is a native weak reference object. Reachability through a native weak reference object is considered of equal strength to phantom reachability. However, unlike a phantom reference object, a native weak reference object is generally dereferenceable.

In an embodiment, the reachability status of any given runtime object residing in a memory area 500 may change. For instance, the reachability status of a runtime object may be downgraded, and/or the reachability status of a runtime object may be upgraded. As used herein, the term “resurrection” refers to an upgrade to a runtime object's reachability status. For example, a runtime object that is merely softly reachable or weakly reachable is said to be “resurrected” if that runtime object subsequently becomes strongly reachable. Softly reachable objects and weakly reachable objects are examples of runtime objects that can be resurrected. Note the resurrection of one runtime object may trigger the resurrection of another runtime object. As an example, assume that reference object 506 is a soft reference object or a weak reference object. Recall that a reference object that is a soft reference object or a weak reference object will typically declare a get( ) method, and calling the get( ) method may return the reference object's referent if the reference object has not been cleared. Note that an operation that involves a successful invocation of a get( ) method of a reference object will typically create a new strong reference to the reference object's referent, and the new strong reference generally will render the referent strongly reachable, at least temporarily. Thus, in this example, if a get( ) method of reference object 506 is successfully invoked (i.e., the get( ) method does not return null), standard object 508 and standard object 510 may both become strongly reachable (and therefore ineligible for collection by a garbage collection cycle). A finalizably reachable runtime object is another example of a runtime object that can be resurrected. As an example, assume that standard object 512 is a finalizably reachable object. In this example, executing the finalizer method targeting standard object 512 may temporarily render standard object 512 strongly reachable by creating a temporary strong reference to standard object 512 that originates from outside of memory area 500. However, note that if standard object 512 subsequently reverts back to being not reachable in this example (as might be expected in the example depicted by FIG. 5), the corresponding finalizer method will not be called again to resurrect standard object 512 a second time.

### 3. Garbage Collection System

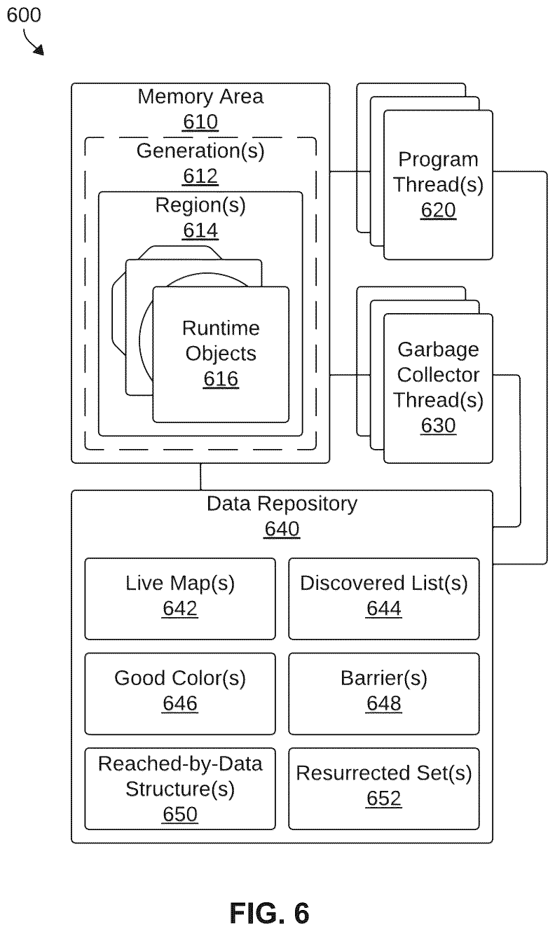

FIG. 6 illustrates a system 600 for performing techniques described herein in accordance with one or more embodiments. As illustrated in FIG. 6, system 600 includes memory area 610, program thread(s) 620, garbage collector thread(s) 630, and data repository 640. In one or more embodiments, system 600 may include more or fewer components than the components illustrated in FIG. 6. The components illustrated in FIG. 6 may be local to or remote from each other. The components illustrated in FIG. 6 may be implemented in software and/or hardware. Each component may be distributed over multiple applications and/or machines. Multiple components may be combined into one application and/or machine. Operations described with respect to one component may instead be performed by another component.

In an embodiment, system 600 refers to hardware and/or software configured to perform a garbage collection process. As used herein, the term “collection operation” may refer to any operation that is performed in furtherance of a garbage collection process, and the term “program operation” may refer to any operation other than a collection operation. During the garbage collection process, the system 600 is configured to complete garbage collection cycle(s). A garbage collection cycle that is performed by system 600 may include multiple phases of collection operations. An example garbage collection cycle includes a marking phase, a reference processing phase, a selection phase, a relocation phase, and/or other phases. As used herein, the term “marking operation” refers to a collection operation that occurs during a marking phase, the term “reference processing operation” refers to a collection operation that occurs during a reference processing phase, the term “selection operation” refers to a collection operation that occurs during a selection phase, and the term “relocation operation” refers to a collection operation that occurs during a relocation phase. Note that any given phase of a garbage collection cycle may be a concurrent phase. A garbage collection cycle that includes at least one concurrent phase is referred to herein as a “concurrent garbage collection cycle.” Additional embodiments and/or examples related to a garbage collection cycle are described below in Section 4 titled “Garbage Collection Cycle.”

Additional embodiments and/or examples relating to performing a garbage collection process are described within R01333N2 and R01333N3. R01333N2 and R01333N3 are incorporated by reference in entirety as if set forth herein.

In an embodiment, system 600 refers to hardware and/or software configured to deterministically terminate a concurrent phase. Additional embodiment and/or examples related to deterministically terminating a concurrent phase are described below in Section 5 titled “Deterministically Terminating a Phase of Concurrent Operations.”

In an embodiment, memory area 610 is any type of storage unit and/or device (e.g., a file system, database, collection of tables, or any other storage mechanism) for storing data. Furthermore, memory area 610 may include multiple different storage units and/or devices. The multiple different storage units and/or devices may or may not be of the same type or located at the same physical site. Memory area 610 is implemented or executed on the same computing system as other components of system 600, and/or memory area 610 is implemented or executed on a computing system that is separate from other components of system 600. Memory area 610 is communicatively coupled to other component(s) of system 600 via physical link(s), and/or data repository 640 is communicatively coupled to other component(s) of system 600 via wireless link(s). Memory area 610 may include volatile memory, and/or memory area 610 may include non-volatile memory.

In an embodiment, memory area 610 is allocated for runtime memory of a single program instance, or memory area 610 is allocated for runtime memory of multiple program instances. The program instance(s) may be implemented, in whole or in part, using one or more class-based, object-oriented programming languages. Examples of class-based, object-oriented programming languages include Java, C++, C #, Python, Ruby, and others. In the example context of virtual machine memory layout 300 as illustrated in FIG. 3, memory area 610 may reside in heap 302, and runtime objects 616 may be manifested as instances of reference types (e.g., classes) that are instantiated during the runtime of at least one program instance. This implementation of memory area 610 in the context of class-based, object-oriented program language(s) is described herein for illustrative purposes and is not intended to define any limits to the disclosure. It should be understood that the techniques described herein are equally applicable to other contexts and computing environments.

In an embodiment, memory area 610 is organized into multiple generations 612. A generation 612 is a section of memory area 610 that is used to organize information stored to memory area 610. An example generation 612 is a logical subdivision of memory area 610. Note that a logical subdivision of memory area 610 need not be associated with any spatial boundaries within memory area 610. A runtime object 616 may be organized into a generation 612 based on temporal attributes, reachability status, type, and/or other characteristics. Example temporal attributes of a runtime object 616 include time elapsed since the runtime object 616 was created, time elapsed since the runtime object 616 was last accessed, time elapsed in relation to the creation or use of another runtime object 616, and others. In an example, memory area 610 includes a young generation, and memory area 610 includes an old generation. Note that the boundaries of a generation 612 are not necessarily demarcated based on any temporal attributes of runtime objects 616.

In an embodiment, information stored to memory area 610 is organized into region(s) 614. A region 614 is a basic unit of memory allocation within memory area 610 that may be independently managed during a garbage collection cycle. For example, during a garbage collection cycle, an individual region 614 may be selected as a candidate region for relocation operations.

In an embodiment, runtime objects 616 includes root object(s), standard object(s), reference object(s), and/or other types of runtime objects 616. If a runtime object 616 is a reference object, the runtime object 616 is a soft reference object, a weak reference object, a final reference object, a phantom reference object, or another type of reference object. A runtime object 616 may refer to another runtime object 616 residing in memory area 610. If a runtime object 616 refers to another runtime object 616, the runtime object 616 refers to a single other runtime object 616, or the runtime object 616 refers to multiple other runtime objects 616. A runtime object 616 residing in memory area 610 is exposed at a program level, or the runtime object 616 is not exposed at the program level (e.g., a final reference object).

In an embodiment, a runtime object 616 residing in memory area 610 is eligible for collection by a garbage collection process, or the runtime object 616 is ineligible for collection by a garbage collection process. As used herein, the term “disposable” refers to eligibility for collection by a garbage collection process, and the term “non-disposable” refers to ineligibility for collection by a garbage collection process. Note that a runtime object 616 that is deemed to be disposable during a garbage collection cycle is not necessarily collected by that garbage collection cycle. In an example, a garbage collection cycle targeting memory area 610 reclaims the memory that is occupied by the disposable runtime objects 616 residing in a subset of the regions 614 within memory area 610. Thus, disposable runtime objects 616 not residing in the subset of the regions 614 are not collected during the garbage collection cycle of this example.

In an embodiment, a runtime object 616 is a strongly reachable object, a softly reachable object, a weakly reachable object, a finalizably reachable object, a phantom reachable object, or an unreachable object. A runtime object's 616 eligibility for collection during a garbage collection cycle may depend upon the runtime object's 616 reachability status and/or other factors. For example, strongly reachable objects are typically considered non-disposable, whereas unreachable objects are typically considered disposable. A runtime object that is reachable but less than strongly reachable may be considered disposable or non-disposable depending on the circumstances. Note that in some cases, a runtime object 616 may be treated as strongly reachable (and therefore non-disposable) regardless of whatever that runtime object's 616 actual reachability status may be. It should also be noted that a runtime object's 616 eligibility for collection by a garbage collection cycle may depend on factors other than the runtime object's 616 reachability status.

In an embodiment, a runtime object 616 is a live object, or the runtime object 616 is a dead object. As used herein, the term “live object” refers to a runtime object that is marked as live in at least one record of state information, and a “dead object” refers to a runtime object that has not been marked as live. A runtime object 616 marked as live during a garbage collection cycle is generally not collected by that garbage collection cycle. On the other hand, a runtime object 616 that is not marked as live during a garbage collection cycle (i.e., a dead object) may or may not be collected by that garbage collection cycle. Note that a runtime object 616 may be a live object during one garbage collection cycle, and the runtime object 616 may be a dead object during a subsequent garbage collection cycle.

As illustrated in FIG. 6, system 600 may be implemented, at least in part, using a multi-thread computing system. A multi-thread computing system is one example of a computing system capable of performing concurrent operations. The implementation of system 600 in the context of a multi-thread computing system is described herein for illustrative purposes and is not intended to define any limits to this disclosure. It should be understood that techniques herein are equally applicable to other computer architectures. For instance, the techniques described herein may be applicable to any computer architecture that is capable of concurrency.

In an embodiment, program thread(s) 620 are execution environment(s) for machine-level instructions. A program thread 620 is primarily allocated for performing the machine-level code of a program instance. Accordingly, a program thread 620 generally performs program operations. Note that when a program thread 620 is performing the machine-level code of a program instance, runtime objects 616 that are not exposed at a program level (e.g., final reference objects) are inaccessible to that program thread 620 because the machine-level code of the program instance is unable to describe resources that are not exposed at a program level. While a program thread 620 generally performs program operations, the program thread 620 may be further configured to execute machine-level code of a garbage collection process (i.e., collection operations). In particular, a program thread 620 can be made to perform collection operations by imposing a barrier 648 (e.g., a load barrier or a store barrier) on that program thread 620. Recall that the term “barrier” refers to an additional set of machine-level instructions inserted into the machine-level code that is performed by an execution environment. In the example context of execution platform 112 as illustrated in FIG. 1, a barrier is imposed on a program thread 620 when JIT compiler 109 inserts the machine-level instructions defined by the barrier into the machine-level code of the program instance that is being performed by that program thread 620.

In an embodiment, garbage collector thread(s) 630 are execution environment(s) for machine-level instructions. A garbage collector thread 630 is configured for performing machine-level code of a garbage collection process. Accordingly, a garbage collector thread 630 primarily performs collection operations. Note that a garbage collector thread 630, while performing a collection operation, may access information that is not exposed at a program level. For example, a garbage collector thread 630 may access final reference objects, and a garbage collector thread 630 may traverse final references to access finalizably reachable objects.

In an embodiment, garbage collector thread(s) 630 are configured to perform collection operations while program thread(s) 620 are concurrently performing program operations. For instance, while a program thread 620 is performing program operations, a garbage collector thread 630 may be performing marking operations, reference processing operations, selection operations, relocation operations, and/or other collection operations. Recall that a program thread 620 may perform collection operations pursuant to a barrier. Note that a program thread 620 may perform a collection operation pursuant to a barrier while another program thread 620 is concurrently performing a program operation. It should also be noted that the term “garbage collector” is used herein to refer broadly to any execution environment that is performing a collection operation. Thus, in example context of system 600 as illustrated in FIG. 6, the term “garbage collector” may be used herein to identify a program thread 620 performing a collection operation, and the term “garbage collector” may be used herein to identify a garbage collector thread 630 performing a collection operation.

In an embodiment, program thread(s) 620 and garbage collector thread(s) 630 are configured to generate and/or update records of state information while performing collection operations. Stated differently, a garbage collector is configured to generate records of state information. Example records of state information include a live map 642, a discovered list 644, a colored pointer, a reached-by-data structure 650, a resurrected set 652, a remembered set, and others. As used herein, the term “marking” refers generally to recording state information. For example, during a marking phase a garbage collector “marks through” runtime objects 616 residing in memory area 610 to generate records of state information. However, note that a garbage collector may record state information (e.g., by marking through runtime objects 616) throughout a garbage collection cycle (e.g., during a reference processing phase, a selection phase, a relocation phase, etc.). It is also worth noting here that the term “marking operation” does not necessarily refer to marking through a runtime object 616. Recall that the term “marking operation” refers to any collection operation (marking or otherwise) that occurs during a marking phase. A garbage collector may perform operations during a marking phase that do not entail writing to a record of state information. Thus, the term “marking operation” does not necessarily identify an operation that entails recording state information.

In an embodiment, a data repository 640 is any type of storage unit and/or device (e.g., a file system, database, collection of tables, or any other storage mechanism) for storing data. Furthermore, a data repository 640 may include multiple different storage units and/or devices. The multiple different storage units and/or devices may or may not be of the same type or located at the same physical site. Furthermore, a data repository 640 may be implemented or executed on the same computing system as other components of system 600. Additionally, or alternatively, a data repository 640 may be implemented or executed on a computing system separate from other components of system 600. The data repository 640 may be communicatively coupled to other components of system 600 via a direct connection or via a network.

As illustrated in FIG. 6, data repository 640 includes live map(s) 642, discovered list(s) 644, good color(s) 646, barrier(s) 648, reached-by-data structure(s) 650, and resurrected set(s) 652. Information describing live map(s) 642, discovered list(s) 644, good color(s) 646, barrier(s) 648, reached-by-data structure(s) 650, and resurrected set(s) 652 may be implemented across any of the components within system 600 (those depicted in FIG. 6 or otherwise). However, this information is illustrated within data repository 640 for purposes of clarity and explanation.

In an embodiment, a live map 642 records the state of runtime object(s) 616 residing in memory area 610. An example live map 642 is a bit map that indicates (a) if a runtime object 616 is live, (b) if the runtime object 616 is strongly reachable, and/or (c) other state information of the runtime object 616. A live map 642 may describe the state of runtime objects 616 throughout memory area 610, the state of runtime objects 616 residing in a particular generation 612 of memory area 610, the state of runtime objects 616 residing in a particular region 614 of memory area 610, and/or the state of runtime objects 616 residing in some other subdivision of memory area 610. If a runtime object 616 is marked as live and/or strongly reachable in a live map 642 during a garbage collection cycle, that runtime object 616 is typically treated as non-disposable for the remainder of that garbage collection cycle. Based on a live map 642, a garbage collector may (a) determine whether or not a reference object should be cleared, (b) select a candidate region 614 to be subjected to relocation operations, (c) identify a runtime object 616 that should be relocated, (d) identify a runtime object 616 that should be collected, and/or (e) perform other collection operations. Whether or not a runtime object 616 is marked as live in a live map 642 may depend on the runtime object's reachability status. In an example, a runtime object 616 is marked as live in a live map 642 if that runtime object is strongly reachable or finalizably reachable. Note that in this example, a finalizably reachable object may need to be retained in memory area 610 until the corresponding finalizer method has been executed. Additionally, or alternatively, the runtime object 616 of this example may be marked as live if that runtime object 616 is softly reachable. Note that whether or not a softly reachable object is marked as live may depend on various factors (e.g., a discovery policy, memory pressure, etc.). If the runtime object 616 is phantom reachable in this example, the runtime object 616 is not marked as live in the live map 642. However, it should be noted that (a) factors other than a runtime object's 616 reachability status may control whether or not the runtime object 616 is marked as live and/or strongly reachable in a live map 642, and (b) a runtime object 616 being marked as live in a live map 642 is not necessarily a reliable indicator of the runtime object's 616 actual state. If a garbage collector discerns any reason for a runtime object 616 to be exempted from collection, the garbage collector may designate that runtime object 616 as live and/or strongly reachable in a live map 642 regardless of whatever the runtime object's 616 actual reachability status may be.

In an embodiment, a discovered list 644 is a list of reference object(s) that may be eligible for reference processing. A discovered list 644 may include soft reference objects, weak reference objects, final reference objects, phantom reference objects, and/or other reference objects. In general, a reference object may be eligible for reference processing if the reference object's referent is not strongly reachable. In an example, a discovered list 644 is generated by a garbage collector during a marking phase while the garbage collector is marking through (a) strongly reachable objects and (b) finalizably reachable objects. Note that a discovered list 644 may be updated during a reference processing phase prior to the system processing any constituent reference objects of the discovered list 644 (e.g., to reflect a resurrection). It should also be noted that a reference object's (e.g., a soft refence object) eligibility for inclusion in a discovered list 644 may depend on a discovery policy that is being applied during a garbage collection cycle. As used herein, a “discovery policy” refers to a rule set for generating record(s) of state information.

In an embodiment, a good color 646 is a value that is used for coloring pointers that refer to runtime objects 616. As used herein, “coloring a pointer” refers to embedding metadata into bit(s) within the pointer that are not being used for storing an address of a location in memory. For example, a garbage collector may color a pointer by embedding a good color 646 into bits within the pointer that are not being used for storing an address associated with a runtime object 616. Note that a reference to a runtime object 616 may be implemented in low-level memory, at least in part, using a pointer. In general, a garbage collector colors pointers to record state information of the pointers and/or runtime objects 616 that are referred to by the pointers. Good colors 646 may be stored to global variables, stored to thread-local variables, encoded into barriers 648, and/or maintained in any other location that is readily accessible to a program thread 620 and/or a garbage collector thread 630. Note that during a garbage collection cycle, a garbage collector may determine new good colors 646. For example, a garbage collector may determine new good colors 646 to track a new concurrent phase of a garbage collection cycle. When a garbage collector determines new good colors 646, the previous good colors 646 become bad colors.

In an embodiment, a barrier 648 is additional set of machine-level instructions that is inserted into the machine-level code that is performed by an execution environment. Barriers 648 may be imposed on program threads 620, garbage collector threads 630, and/or other execution environments. By imposing a barrier 648 on a thread, system 600 compels that thread to perform additional operations. For example, the system 600 temporarily commandeers a program thread 620 to perform collection operations by imposing a barrier 648 on that program thread 620. The system 600 often imposes barriers on program threads 620 during concurrent phases. In addition to serving other purposes, the collection operations required by the barriers imposed on program threads 620 contribute to system 600 preventing concurrency issues that might otherwise occur due to program threads 620 performing program operations in the memory area 610 during a concurrent phase. Example barriers include load barriers, store barriers, and others. A load barrier is a barrier 648 that is imposed on a thread that is attempting a load operation in memory area 610. An example load operation is a request by a program instance for a program thread 620 to read a reference that is carried in an object field of a runtime object 616. An example load barrier specifies collection operations that a program thread may be required to perform before and/or after a load operation. A store barrier is a barrier 648 that is imposed on a thread that is attempting a store operation in memory area 610. An example store operation is a request by a program instance for a program thread 620 to store a reference to an object field of a runtime object 616. An example store barrier specifies collection operations that a program thread may be required to perform before and/or after a store operation. Example collection operations that may be performed by a program thread pursuant to a store barrier include (a) adding an entry to a store barrier buffer, (b) adding an entry to a remembered set, (c) relocating a runtime object, (d) remapping a pointer, (e) coloring a pointer, (f) adding an entry to the marking stack of a garbage collector thread 630, and/or (g) other collection operations. Note that logic defined in barriers 648 may rely on the metadata that is embedded into colored pointers to determine appropriate collection operations to be performed in response to a given program operation.

In an embodiment, a reached-by-data structure 650 records state information of a runtime object 616 that could be resurrected during a garbage collection cycle. In particular, a reached-by-data structure 650 records state information associated with a runtime object 616 that can be used to update other records of state information (e.g., a live map 642, a discovered list 644, colored pointers, a remembered set, etc.) in the event that the runtime 616 is resurrected. Recall that the term “resurrection” refers to an upgrade to a runtime object's 616 reachability status. For example, a resurrection occurs when a runtime object 616 that was formerly softly reachable, weakly reachable, finalizably reachable, phantom reachable, or unreachable becomes strongly reachable. In general, a reached-by-data structure 650 corresponding to a runtime object 616 describes (a) state information of the runtime object 616 and (b) state information of other runtime objects 616 that are linked to the runtime object 616 by chains of reference(s). A garbage collector (e.g., a garbage collector thread 630) may generate a reached-by-data structure 650 while marking through softly reachable objects and/or weakly reachable objects during a marking phase of a garbage collection cycle. A reached-by-data structure 650 corresponding to a runtime object 616 may indicate (a) any reference objects that might be used to resurrect the runtime object 616, (b) any finalizer methods that might be used to resurrect the runtime object 616, (c) other runtime objects 616 whose reachability status will be changed if the runtime object 616 is resurrected, and/or (d) other state information. In effect, a reached-by-data structure 650 is a prediction of how the reachability of runtime objects 616 residing in memory area 610 may change as a result of a resurrection. As an example, consider a runtime object 616 that is a referent of a dereferenceable reference object (e.g., a soft reference object or a weak reference object). For the purposes of this example, assume that (a) the reference object is strongly reachable, and (b) the runtime object 616 is not strongly reachable. In this example, as long as the reference object has not been cleared and remains reachable, a program thread 620, while executing a program instance, may call a get( ) method of the reference object and thereby resurrect the runtime object 616. In particular, calling that get( ) method in this example will render the runtime object 616 strongly reachable for at least a short period of time. Note that if the runtime object 616 of this example (a) strongly refers to another runtime object 616 that is not strongly reachable and (b) is resurrected, the other runtime object 616 will also become strongly reachable. Further note that the runtime object 616 may strongly refer to multiple runtime objects 616, and the multiple runtime objects 616 may, in turn, strongly refer to additional runtime objects 616. In this example, the reached-by-data structure 650 generated for the runtime object 616 will (a) identify the reference object and (b) identify any other runtime objects 616 that would become strongly reachable through the runtime object 616 if the runtime object 616 is resurrected.

In an embodiment, a resurrected set 652 is a list of resurrections. A resurrected set 652 is used by a garbage collector to identify resurrections that occurred during a termination procedure for a concurrent marking phase. Based on a resurrected set 652, a garbage collector can identify any reached-by-data structures 650 that will be needed to update other records of state information (e.g., a live map 642, a discovered list 644, etc.) in view of any resurrections that occurred during a termination procedure. Note that a resurrected set 652 can be used by a program thread 620 executing a load barrier to determine if a runtime object 616 was resurrected during a termination procedure even if the system 600 has not yet updated other records of state information (e.g., a live map 642) to reflect the resurrection. An example resurrected set 652 is a list of reference objects that are used to resurrect the reference object's referents during a termination procedure for a concurrent marking phase of a garbage collection cycle. The example resurrected set 652 is generated by program thread(s) 620 executing barrier(s) 648. Specifically, the example resurrected set 652 is generated by any program threads that performed the program operations resulting in the resurrections listed in the example resurrected set 652. In other words, the example resurrected set 652 is generated by mutators during the termination procedure.

### 4. Garbage Collection Cycle

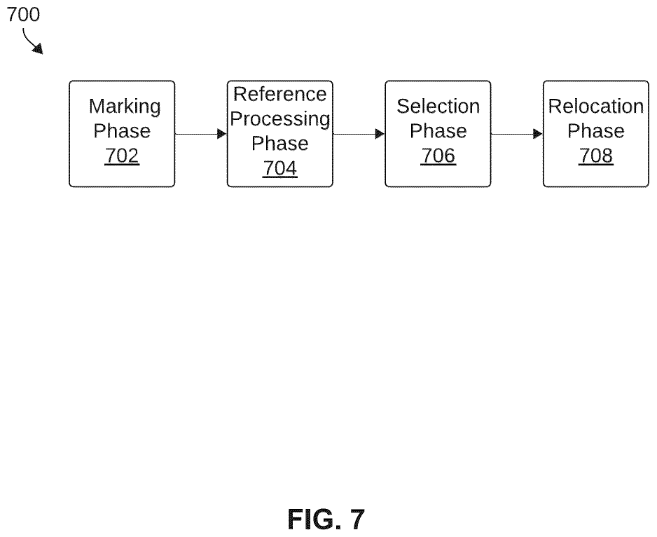

FIG. 7 illustrates an example architecture for a garbage collection cycle 700 in accordance with one or more embodiments. As illustrated in FIG. 7, garbage collection cycle 700 may include marking phase 702, reference processing phase 704, selection phase 706, and relocation phase 708. In one or more embodiment, garbage collection cycle 800 may include more or fewer phases than the phases illustrated in FIG. 7, and/or one or more phases illustrated in FIG. 7 may be modified, rearranged, or omitted all together. Accordingly, the particular sequence of operations illustrated in FIG. 7 should not be construed as limiting the scope of one or more embodiments. Furthermore, it should be understood that a garbage collection 700 may include collection operations that do not occur during any particular phase of the garbage collection cycle 700. For example, collection operations may occur before, after, and/or in between phases of a garbage collection cycle 700.

In an embodiment, garbage collection cycle 700 is a concurrent garbage collection cycle. Therefore, at least one phase of garbage collection cycle 700 (e.g., marking phase 702, reference processing phase 704, selection phase 706, relocation phase 708, etc.) is a concurrent phase. During an example concurrent phase of garbage collection cycle 700, a garbage collector thread is performing collection operations in a memory area while at least one program thread is simultaneously enabled to perform program operations in the memory area. If left unchecked, program operations interfering with collection operations during a concurrent phase can result in concurrency issues, such as race conditions, livelock, deadlock, data corruption, memory loss, termination indeterminism, and other problems. In general, the system prevents concurrency issues from arising during a concurrent phase of garbage collection cycle 700 using a combination of a monotonic state machine, pointer coloring, barriers, reached-by-data structures, a resurrected set, and other mechanisms.

In an embodiment, garbage collection cycle 700 includes a marking phase 702. During the marking phase 702, the system marks through runtime objects residing in a memory area to collect state information. While marking through the runtime objects, the system generates records of state information that will be used in subsequent phases of the garbage collection cycle 700 as a basis for collecting runtime objects from the memory area, retaining runtime objects in the memory area, reorganizing the memory area, and/or other collection operations. Example records of state information that may be generated during the marking phase 702 include live maps, discovered lists, colored pointers, reached-by-data structures, remembered sets, resurrected sets, and others. The system may generate a record of state information in accordance with a discovery policy that is selected by the system based on conditions within the memory area, characteristics of a program instance manipulating the memory area, and/or other inputs. In addition to generating records of state information, the system may perform other marking operations during the marking phase 702. For example, if the system encounters a broken pointer while marking through a runtime object, the system repairs the broken pointer by remapping the broken pointer to the correct address. The system may continue to repair broken pointers that are encountered by the system throughout garbage collection cycle 700.

In an embodiment, marking phase 702 is a concurrent phase of garbage collection cycle 700. Thus, during marking phase 702, program operations may be manipulating the memory area at the same time as the system is performing marking operations in the memory area. Note that program operations manipulating the memory area may further complicate marking phase 702. If a program operation alters the reachability status of a runtime object residing in the memory area during marking phase 702, the system may be forced to repeat marking operations, and/or the system may be forced to perform additional marking operations. It should be noted that a mutation can be especially problematic for a concurrent marking phase if that mutation occurs during a termination procedure for the concurrent marking phase. Historically, the occurrence of a mutation during a termination procedure for a concurrent marking phase has been a cause of termination indeterminism. As an example, assume that, during a concurrent marking phase in a memory area, a garbage collector ceases marking through runtime objects and initiates a termination procedure. While performing the termination procedure, the garbage collector of this example attempts to corral the program threads to a safe point in time where a program instance can safely be paused, and the concurrent marking phase can be terminated. For the purposes of this example, further assume that during the termination procedure, a program thread resurrects a referent of a reference object prior to that program thread arriving at the safe point. In particular, the program thread resurrects the referent by calling a get( ) method of the reference object. The resurrection results in the referent becoming strongly reachable. Furthermore, the resurrection of the referent in this example also triggers the resurrection of any other runtime objects that are (a) linked to the referent by a string of strong reference(s) originating from the reference and (b) not strongly reachable prior to the termination procedure. Consequently, records of state information generated during the concurrent marking phase of this example are rendered inaccurate. Recall that (a) records of state information are used as basis for collecting runtime objects from the memory area, and (b) strongly reachable objects are typically considered non-disposable. Thus, in this example, if the garbage collector fails to correct the reachability statuses of the new strongly reachable objects as recorded in the records of state information, the new strongly reachable objects may be erroneously collected from the memory area and data losses and/or program errors may result. Consequently, in this example scenario, a garbage collector has historically been compelled to abort the termination procedure and restart marking operations to mark through the runtime objects that have become strongly reachable during the termination procedure. Once the garbage collector has finished marking through the resurrected runtime objects, the garbage collector restarts the termination procedure anew in this example. However, there is no guarantee that another resurrection will not occur during the new termination procedure in this example; therefore, the garbage collector could once or several times again be forced to abort a termination procedure and restart marking. In view of the foregoing, garbage collectors have historically struggled to deterministically terminate concurrent marking phases.

In an embodiment, marking phase 702 is a snapshot-at-the-beginning (SATB) marking phase, an incremental marking phase, and/or another type of concurrent marking phase. In an example, marking phase 702 is implemented as an SATB phase. As the name suggests, an SATB marking phase begins with the system generating a snapshot of a memory area that is being subjected to a garbage collection cycle. Based on the snapshot, the system identifies root objects residing in the memory area. Starting from the root objects, the system traverses strong references to other strongly reachable objects until no more strongly reachable objects can be found within the memory. In addition to marking through the strong object graph of the memory area in this example, the system marks through runtime objects residing in the memory area that are reachable but less than strongly reachable. For instance, the system may mark through finalizably reachable objects as finalizably reachable objects may need to be retained in the memory area for a corresponding finalizer method to be successfully executed. Furthermore, while generating reached by data structure(s), the system may mark through other runtime objects that could potentially be resurrected. To this end, the system may mark through a part of the runtime objects that could potentially be resurrected, or the system may mark through all of the runtime objects that could potentially be resurrected. Recall that whether or not a referent of a reference object can be resurrected may depend on whether or not that reference object is dereferenceable. In an example application, soft reference objects, weak reference objects, and native weak reference objects are typically dereferenceable prior to clearing. Therefore, in this example application, a runtime object may be a candidate for marking by the system if that runtime object is reachable through at least one chain of reference(s) that (a) includes a soft reference, a weak reference, and/or a native weak reference and (b) does not include a phantom reference. Note that the system need not traverse the object graph to discover native weak references in this example as a native weak reference is automatically discovered upon creation. It should also be noted that this example does not describe an exhaustive list of reference objects, and recall that reachability through a native weak reference object is considered of equal strength to phantom reachability. Further recall that any reference object may be configured to be dereferenceable or non-dereferenceable. For example, while a get( ) method of a phantom reference object is often configured to return null, a get method( ) of a phantom reference object can be configured to return the phantom reference object's referent. In sum of the foregoing, the reachability status of a runtime object is not necessarily a definitive indicator of whether or not that runtime object is a candidate for marking and the reachability statuses of runtime objects that are candidates for marking may vary between applications. In general, any runtime object that could potentially be resurrected is a candidate for marking during marking phase 702 while the system is generating reached by data structure(s).

In an embodiment, garbage collection cycle 700 includes a reference processing phase 704. During reference processing phase 704, the system processes reference objects residing in the memory area. In particular, the system may process reference object(s) that are included in a discovered list. Examples of reference objects that may be found in a discovered list include soft reference objects, weak reference objects, final reference objects, phantom reference objects, and others. Note that a discovery policy that is applied during marking phase 702 may impact the contents of a discovered list, a live map, and/or other records of state information. It should also be noted that before processing the reference objects included in a discovered list, the system may update the discovered list during reference processing phase 704. Once any appropriate updates are applied to a discovered list, the system iterates through the discovered list processing the constituent reference objects. Processing a reference object may entail clearing the reference object, enqueueing the reference object, and/or other reference processing operations. A reference object is cleared by setting the referent field of the reference object to null. Clearing a reference object breaks the non-strong reference that links the reference object to the reference object's referent. Once a reference object has been cleared, the reference object cannot be dereferenced; therefore, that reference object can no longer be used to resurrect the reference object's referent. When a reference object is cleared, the reference object's referent will typically become unreachable unless the referent is also referred to by another reference object. Consequently, clearing a reference object usually results in the reference object's referent being collected during the present garbage collection cycle 700 or a subsequent garbage collection cycle. The system may clear any reference object that is included in a discovered list; however, the system may refrain from clearing a final reference object if the final reference object's referent possesses an uncalled finalizer method. Enqueueing a reference object adds the reference object to an appropriate reference queue. Adding a reference object to a reference queue serves to notify any program instance associated with the reference object that the referent has been collected or will soon be collected. Notifying a program instance of a referent being subjected to collection may signal the program instance to take appropriate actions, such as performing cleanup operations, logging, and/or other post-mortem processing.

In an embodiment, reference processing phase 704 is a concurrent phase of garbage collection cycle 700. Thus, during reference processing phase 704, program operations may be attempting to manipulate reference objects at the same time that the system is attempting to process those reference objects. Note that a program operation manipulating a reference object might interfere with an attempt to process that reference object. For example, concurrency issues might arise if a program operation is allowed to resurrect a reference object included in a discovered list while the system is attempting to process reference objects in the discovered list.

In an embodiment, garbage collection cycle 700 includes selection phase 706. During selection phase 706, the system generates an evacuation candidate set. The evacuation candidate set contains candidate regions. A candidate region is a region of the memory area that may be targeted by a relocation phase 708 of the garbage collection cycle 700. The system selects a candidate region based on records of state information originally generated during the marking phase (e.g., a live map), and/or the system selects the candidate region based on other information. Example inputs that potentially influence the selection of a candidate region by the system include an occupancy level of the candidate region, a capacity of the candidate region, the amount of live object in the candidate region, the amount of dead objects in the candidate region, and other information. In an example, the system selects a candidate region based on a liveness ratio associated with runtime objects residing in the candidate region. In this example, the system calculates the liveness ratio based on a live map that was generated during the marking phase 702, and the candidate region is selected because the liveness ratio indicates that the candidate region has proportionally fewer live objects relative to other regions.

In an embodiment, garbage collection cycle 700 includes relocation phase 708. During relocation phase 708, the system relocates non-disposable runtime objects residing in the candidate regions that are identified in an evacuation candidate set. The non-disposable runtime objects residing in the candidate regions are relocated to other non-candidate regions of the memory area. In general, a runtime object residing in a candidate region may be relocated if that runtime object is marked as live and/or strongly reachable in a live map and/or another record of state information. When the system relocates a runtime object, the system generates an entry for that runtime object in a forwarding table. An example entry in a forwarding table maps the previous address of a runtime object that formerly resided in a candidate region to a post-relocation address of that runtime object in a non-candidate region. In addition to relocating runtime objects and generating a forwarding table, the system may perform other collections operations while relocating the runtime objects. For example, in addition to relocating a runtime object, the system may remap a pointer that refers to that runtime object to the runtime object's new location in the memory area. Furthermore, the system tracks the progression of the relocation phase by coloring pointers that refer to the relocated runtime objects. Once the system has completed relocating the non-disposable runtime objects residing in a candidate region, the system reclaims the memory associated with that candidate region. The disposable runtime objects that are not relocated from a candidate region are effectively collected by the system when the memory allocated to that candidate region is reclaimed.

In an embodiment, relocation phase 708 is a concurrent phase of garbage collection cycle 700. Thus, during relocation phase 708, program operations may be attempting to manipulate runtime objects residing in a candidate region while the system is attempting to perform relocation operations in the candidate region.

### 5. Deterministically Terminating a Phase Of Concurrent Operations

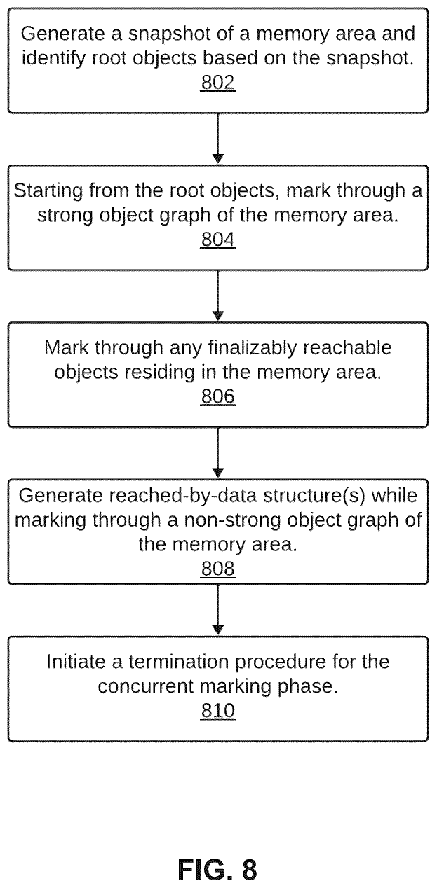

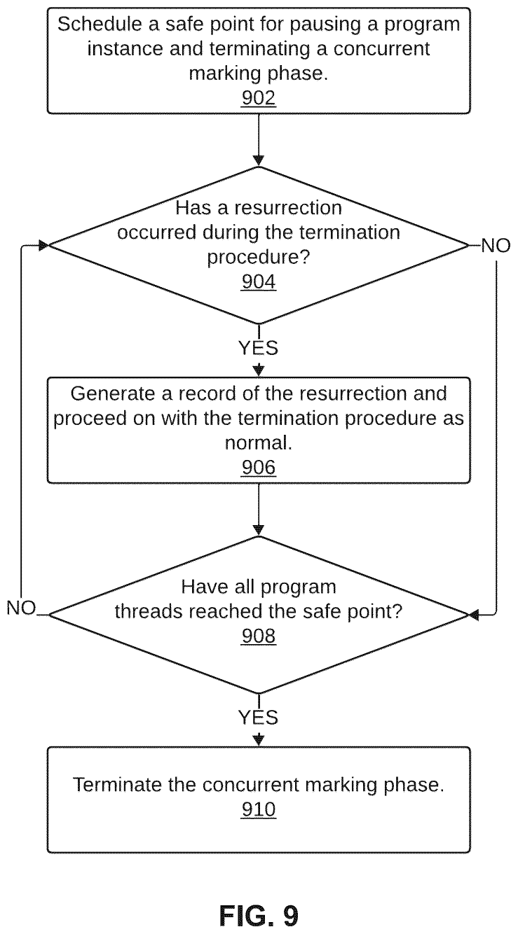

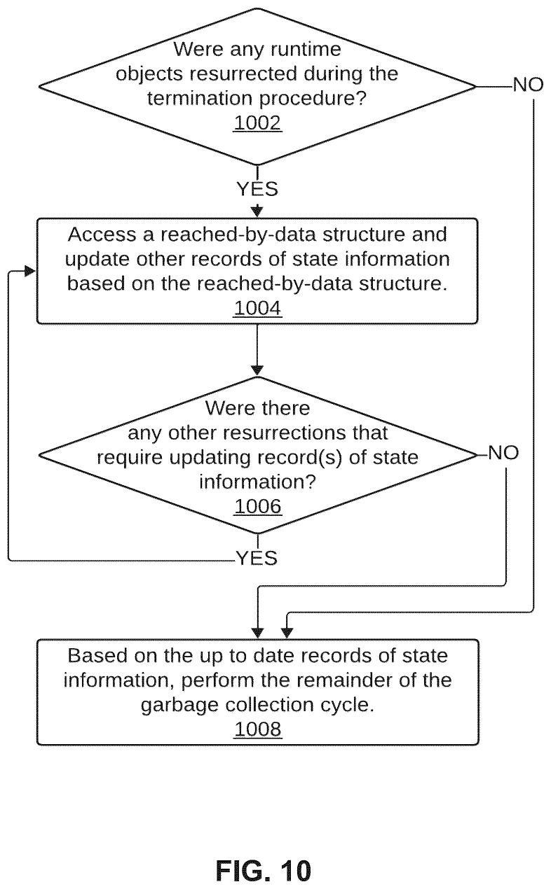

FIG. 8, FIG. 9, and FIG. 10 are flowcharts illustrating techniques for deterministically terminating a concurrent phase. One or more operations illustrated in FIG. 8, FIG. 9, and FIG. 10 may be modified, rearranged or omitted. Accordingly, the particular sequence of operations illustrated in FIGS. 8, 9, and 10 should not be construed as limiting the scope of one or more embodiments. In an embodiment, techniques described herein for deterministically terminating a concurrent phase are applied in the context of a concurrent garbage collection cycle; to provide clear examples, the remainder of the discussion in this Section 5 assumes the same. However, it should be understood that the implementation of these techniques in the context of a concurrent garbage collection cycle is described herein for illustrative purposes and is not intended to define any limits to the disclosure. In general, the techniques described below are applicable to any process, including a concurrent phase that may be a source of termination indeterminism.

### 5.1 Generating Records of State Information

FIG. 8 illustrates an example set of marking operations that may be performed in accordance with one or more embodiments. One or more operations illustrated in FIG. 8 may be modified, rearranged, or omitted all together. Accordingly, the particular sequence of operations illustrated in FIG. 8 should not be construed as limiting the scope of one or more embodiments.

In an embodiment, the system generates a snapshot of a memory area that is being subjected to a concurrent marking phase of a garbage collection cycle (Operation 802). The system generates the snapshot while program thread(s) are paused, or the system generates the snapshot while the program thread(s) are running. In an example of the former scenario, the system ushers the program threads to a safe point where a corresponding program instance can safely be paused. Once the program instance is paused in this example, the system generates the snapshot. Based on the snapshot, the system identifies root objects in the memory area that will be used as a starting point for marking through runtime objects residing in the memory area. At this stage of the garbage collection cycle, the system may also determine new good colors that will be used for coloring pointers. Note that determining new good colors renders the previous good colors bad. Thus, in the instant that immediately follows the determination of the new good colors, all pointers can be expected to have bad colors or no colors. The system will subsequently be able to determine if a pointer and the runtime object referred to by the pointer have been processed during the concurrent marking phase based on whether or not the corresponding pointer holds good colors.

In an embodiment, the system marks through a strong object graph of the memory area (Operation 804). Stated differently, the system marks through the strongly reachable objects residing in the memory area. To mark through the strong object graph, the system traverses chains of strong references that originate from the root objects that are identified in the snapshot. While traversing the chains of strong references, the system records state information of strongly reachable objects and pointers to strongly reachable objects in record(s) of state information. For instance, the system may record state information by (a) writing to a live map, (b) coloring pointers, (c) adding reference objects to a discovered list, (d) adding object fields to a remembered set, and/or (e) writing state information to other records of state information. As an example, consider a garbage collector thread that traverses a strong reference thereby encountering a runtime object that is (a) strongly reachable and (b) unmarked. In this example, the garbage collector thread marks the runtime object as live and strongly reachable in a live map, and the garbage collector thread stores good colors to a pointer to mark the runtime object as reachable and strongly reachable. Further, if (a) the runtime object is a reference object and (b) the reference object's referent is not marked as strongly reachable (e.g., in a live map or a colored pointer), the garbage may add the runtime object to a discovered list pursuant to any discovery policy that is currently in effect. Furthermore, if the runtime object refers to another runtime object that potentially resides in another generation, the garbage collector thread adds the object field holding that reference to a remembered set. Note that the memory area may or may not be organized into multiple generations in this example. Once the garbage collector thread finishes marking through the runtime object, the garbage collector thread will continue to mark through the strong object graph. To this end, the garbage collector thread will check if the runtime object strongly refers to any other runtime objects. If the runtime object strongly refers to another runtime object, the garbage collector thread traverses that strong reference to mark through the other runtime object. Otherwise, the garbage collector thread may backtrack until the garbage collector thread finds another strongly reachable object that has not been marked through. If the garbage collector thread finds no more strongly reachable objects, the garbage collector thread proceeds onwards to the next stage of the marking phase (i.e., marking through runtime objects that are reachable but not strongly reachable).

The system, according to an embodiment, may employ various traversal algorithms for marking through objects (strongly reachable or otherwise). Examples of traversal algorithms that may be employed by the system during the marking phase include a depth-first search (DFS) algorithm, a breadth-first search (BFS) algorithm, a backtracking algorithm, an iterative deepening DFS (IDDFS) algorithm, a Trajan's algorithm, a Kosaraju's algorithm, and/or other algorithms.

The system, according to an embodiment, largely delegates the responsibility for marking through runtime objects residing in the memory area to garbage collector threads. However, it should be noted that program thread(s) may also perform some marking operations pursuant to barriers that the program thread(s) are made to execute before or after performing some program operation in the memory area. In an example, while performing a load operation or a store operation in the memory area, a program thread is made to execute a load barrier and/or a store barrier. Pursuant to the load barrier and/or the store barrier, the program thread may strip bad colors from a pointer, store good colors to a pointer (e.g., to mark an object as live and/or strongly reachable), repair a broken pointer, add an object field to a remembered set, and/or perform other collection operations.

In an embodiment, the system marks through finalizably reachable objects residing in the memory area (Operation 806). The system identifies finalizably reachable objects by traversing chains of references that originate from final reference objects. While marking through a finalizably reachable object, the system may update a live map, color a pointer, update a remembered set, generate a reached-by-data structure, and/or update other records of state information. As an example, assume that a garbage collector thread traverses a final reference to find a finalizably reachable referent of a final reference object. In this example, the garbage collector thread (a) marks the referent as live in a live map, (b) colors a pointer to the referent to mark the referent as reachable, and (c) adds the final reference object to a discovered list. Having marked through the referent of this example, the garbage collector thread will proceed onward to mark through any other runtime objects that are finalizably reachable through the referent. If there are no other runtime objects that are finalizably reachable through the referent in this example, the garbage collector thread will look for another final reference object having a referent that has not been marked. Note that the system marks finalizably reachable objects as live in a live map because a finalizably reachable object may need to be retained in the memory area for a corresponding finalizer method to be successfully executed.

In an embodiment, the system generates reached-by-data structure(s) while marking through a non-strong object graph of the memory area (Operation 808). The system may generate a reached-by-data structure for any runtime object residing in the memory area that could be resurrected. Recall that a runtime object may be resurrected by dereferencing a reference object, calling a finalizer method, and/or through other mechanisms. In an example, the system begins the process of generating a reached-by-data structure by searching for dereferenceable reference objects residing at the periphery of the memory area's strong object graph. In particular, a garbage collector thread of this example searches for strongly reachable soft reference objects, strongly reachable weak reference objects, and any other reference objects at the periphery of the strong object graph that are (a) strongly reachable and (b) potentially dereferenceable. Recall that unlike soft reference objects and weak reference objects, phantom reference objects and final reference objects are generally not dereferenceable. Therefore, phantom reference objects and final reference objects generally cannot be used by a program thread executing a program instance to resurrect a referent. However, recall that, in some cases, a phantom reference object may be configured as dereferenceable. Accordingly, the garbage collector thread may also search for phantom reference objects at the periphery of memory area's strong object graph in this example. Upon finding a strongly reachable reference object that remains dereferenceable, the garbage collector thread of this example checks if the reference object's referent is marked as strongly reachable. If the referent is not marked as strongly reachable, the garbage collector thread may generate a reached-by-data structure for that referent in this example. Starting from the referent, the garbage collector thread of this example looks for other runtime objects that are reachable through the referent. At a minimum, the garbage collector thread of this example searches for other runtime objects that are (a) not strongly reachable and (b) are linked to the referent by a chain of strong reference(s) originating from the referent. In other words, the garbage collector thread of this example will at least attempt to identify the runtime objects that are certain to become strongly reachable if the referent becomes strongly reachable. Having identified any other runtime objects that will be resurrected if the referent is resurrected in this example, the garbage collector thread records the state information of those runtime objects into the reached-by-data structure. The garbage collector thread may include in the reached-by-data structure any state information that would be needed to update other records of state information (e.g., a live map, a discovered list, colored pointers, a remembered set, etc.) if the referent is resurrected in this example. Note that a discovery policy may impact the runtime objects that the system marks through while generating a reached-by-data structure.

The system, according to an embodiment, updates other records of state information while marking through the non-strong object graph to generate reached-by-data structure(s). For instance, while traversing the non-strong object graph, the system stores good colors to pointers referencing runtime objects in the non-strong object graph to mark those runtime objects as reachable. Furthermore, if (a) the memory area includes multiple generations and (b) the system encounters a reference to another generation while marking through a non-strong object graph of one generation, the system may add the object field holding that reference to a remembered set.

The system, according to an embodiment, generates a reached-by-data structure for each runtime object that could be resurrected during a termination procedure for the concurrent marking phase, or the system generates a reached by a data structure for a subset of the runtime objects that could be resurrected during a termination procedure for the concurrent marking phase. In the later scenario, the system may prioritize generating reached-by-data structures for some runtime objects over other runtime objects. As an example, consider two runtime objects that could be resurrected, and assume that the system assesses that a resurrection of one runtime object is more likely than a resurrection of the other runtime object. Therefore, the system of this example generates a reached-by-data structure for the one runtime object instead of or before generating another reached-by-data structure for the other runtime object. As another example, consider two runtime objects that could be resurrected. In this example, the system presumes that the probability of one runtime object being resurrected is equal to the probability of the other runtime object being resurrected. However, the system assesses that generating a reached-by-data structure for the runtime object will require less time and/or less resources than generating a reached-by-data structure for the other runtime object. Therefore, the system generates a reached-by-data structure for the one runtime object instead of or before generating another reached-by-data structure for the other runtime object. Note that in this example, a resurrection of the other runtime object may trigger a larger expansion to the strong object graph than a resurrection of the one runtime object. However, note that the opportunity cost of cancelling a termination procedure in view of the one runtime object being resurrected may be no different than the opportunity cost of canceling a termination procedure in view of the other runtime object being resurrected.

Once the system has finished marking through runtime objects and generating the reached-by-data structures, the system may conclude that the concurrent marking phase can be terminated. Note that system may not mark through all reachable objects in the memory area prior to ceasing marking operations. It should also be noted that system's criteria for concluding the concurrent marking phase can be terminated may differ between applications. For example, in one application, the system may generate proportionally fewer reached-by-data structures and mark through a lesser proportion of reachable objects, whereas in another application, the system may generate proportionally more reached-by-data structures and mark through a greater proportion of reachable objects. In general, at what point the system determines marking can cease will depend on the circumstances of a given application.

The system may alter the criteria for ceasing marking operations to maximize the efficiency of garbage collection cycles on aggregate. For instance, if the system finds that a significant proportion of the reached-by-data structures that are generated during garbage collection cycles are consistently underutilized, the system may alter the criteria for ceasing marking operations, so fewer reached-by-data structures are generated. As a result, less time and resources may be expended during the concurrent marking phases. On the other hand, if the system finds that an inadequate number of reached-by-data structures are consistently being generated, the system may alter the criteria for ceasing marking operations, so more reached-by-data structures are generated. Note that an ideal point for ceasing marking operations may vary based on the characteristics of a program instance and a memory area. For instance, a program that relies more heavily on reference objects and finalizers may be associated with a higher frequency of resurrections. To account for differences between applications, the system may train a machine learning model to select a stopping point for marking operations. The machine learning model is trained to select a stopping point based on characteristics of a program instance, characteristics of a memory area, conditions within a memory area (e.g., memory pressure, and/or other information. Historical data from previous applications of the system may be utilized as a source of training data. The system may generate additional training data for the machine learning model during any given application of the system, and the system may update the trained machine learning model accordingly.

In an embodiment, the system, having determined that concurrent marking operations can be terminated, initiates a termination procedure for the concurrent marking phase (Operation 810). Example operations that may be performed in accordance with a termination procedure for the concurrent marking phase are described below with reference to FIG. 9.

### 5.2 Terminating a Concurrent Marking Phase

FIG. 9 illustrates an example set of marking operations that may be performed in accordance with one or more embodiments. One or more operations illustrated in FIG. 9 may be modified, rearranged, or omitted all together. Accordingly, the particular sequence of operations illustrated in FIG. 9 should not be construed as limiting the scope of one or more embodiments.

In an embodiment, the system schedules a safe point where a program instance that is being executed by at least one program thread can be safely paused (Operation 902). An example safe point is a point where all program threads reach a known safe state, and the system can suspend the program threads without potentially causing any issues in program logic or risking data integrity. Note that during the termination procedure, the program thread(s) may continue performing program operations until arriving at the safe point. Consequently, during the termination procedure, a program thread may resurrect a runtime object prior to arriving at the safe point. For example, a program thread may perform a load operation and/or a store operation on a runtime object that causes the runtime object to become strongly reachable. Note that in this example, the particular object may strongly refer to other runtime objects. If the other runtime objects were not previously strongly reachable, the other runtime objects also become strongly reachable. Further note that the other runtime objects may in turn strongly refer to more runtime objects that were previously not strongly reachable. As such, a single resurrection may trigger a large expansion to a strong object graph of the memory area.

In an embodiment, the system determines if any resurrections have occurred during the termination procedure, and the system proceeds to another operation based on the determination (Operation 904). If a resurrection has occurred during the termination procedure (YES in Operation 904), the system proceeds to Operation 906. Recall that if a resurrection occurs during a termination procedure, a record of state information generated during a concurrent marking phase (e.g., live maps, discovered list, etc.) may be rendered inaccurate. Alternatively, if no resurrection has occurred during the termination procedure (NO in Operation 904), the system proceeds to Operation 908.

In an embodiment, the system generates a record of any resurrections that occurred during the termination procedure (Operation 906). To record a resurrection, the system generates an entry in a resurrected set. For instance, if a reference object is used by a program instance to resurrect the reference object's referent during the termination procedure, the system adds that reference object to a resurrected set. Note that the system does not abort the termination procedure for the concurrent marking phase in response to a resurrection. Apart from generating an entry in a resurrected set, the system proceeds onward with the termination procedure as if no resurrection has occurred. Accordingly, the concurrent marking phase will be terminated at the safe point regardless of whether or not any resurrections occur. The system is enabled to deterministically terminate the concurrent marking phase even when a resurrection occurs during the termination procedure due to the system having recorded a precomputed impact of the resurrection in a reached-by-data structure.

The system, according to an embodiment, generates a record of a resurrection by imposing a barrier on a program thread (i.e., a mutator) that resurrects a runtime object during the termination procedure. As an example, assume that a program thread attempts to dereference a reference object to access the reference object's referent while a termination procedure is ongoing, and further assume that the referent is not strongly reachable prior to the termination procedure. In this example, the system identifies the attempt to dereference the reference object in the machine-level code of the program instance, and the system injects a barrier into the machine-level code proximate to the instructions for dereferencing the reference object. The program thread, acting pursuant to the barrier of this example, adds the reference object to a resurrected set to record the resurrection. Note that in this example, the program thread, acting pursuant to the barrier, is able to determine that dereferencing the reference object will resurrect the referent based on the state information that is embedded into a colored pointer that refers to the referent. In particular, the program thread of this example knows that the referent will be resurrected because the colored pointer indicates the referent is reachable but not strongly reachable. It should also be noted that, depending on the barrier (e.g., a load barrier vs. a store barrier), the program thread may perform other collection operations. For instance, the barrier might require the program thread to store another good color to the pointer to reflect the referent becoming strongly reachable.

In an embodiment, the system determines if all of the program threads have reached the scheduled safe point, and the system proceeds to another operation based on the determination (Operation 908). If all program threads have arrived at the safe point (YES in Operation 908), the system proceeds to Operation 910. Alternatively, if all program threads have not yet arrived at the safe point (NO in Operation 908), the system returns to Operation 904.

In an embodiment, the system pauses the program instance, and the system terminates the concurrent marking phase (Operation 910). Note that if any resurrections occurred during the termination procedure, records of state information may need to be updated before the system can rely on those records of state information as a basis for performing other collection operations. Example operations for updating records of state information are described below with reference to FIG. 10.

### 5.3 Updating Records of State Information

FIG. 10 illustrates an example set of reference processing operations that are performed in accordance with one or more embodiments. One or more operations illustrated in FIG. 10 may be modified, rearranged, or omitted all together. Accordingly, the particular sequence of operations illustrated in FIG. 10 should not be construed as limiting the scope of one or more embodiments.

In an embodiment, the system determines if any runtime objects were resurrected during a termination procedure for a concurrent marking phase, and the system proceeds to another operation based on the determination (Operation 1002). The system may determine if any resurrection occurred based on a resurrected set that will have been generated during the termination procedure if any resurrection occurred. If any resurrections occurred during the termination procedure (YES in Operation 1002), the system proceeds to Operation 1004. Alternatively, if no resurrections occurred during the termination procedure (NO in Operation 1002), the system proceeds to Operation 1008. Note that the system need not concern itself with any resurrections that may have occurred prior to the termination procedure.

In an embodiment, the system accesses a reached-by-data structure corresponding to a resurrected runtime object, and the system updates other records of state information based on the reached-by-data structure (Operation 1004). Example records of state information that may be updated based on the reached-by-data structure include a live map, a discovered list, colored pointers, and others. In general, the system updates a live map to indicate that the resurrected runtime object is live and/or strongly reachable, and/or the system updates the live map to reflect any other runtime objects that have become live and/or strongly reachable as a result of the resurrection. Similarly, the system, based on the live map, updates the coloring of pointers as needed to reflect any changes to the reachability statuses of runtime objects that occur due to the resurrection. The system removes a reference object from a discovered list based on the reached-by-data structure if that reference object's referent has become strongly reachable as a result of the resurrection. Furthermore, if the system finds a reference object in the reached-by-data structure that (a) has become strongly reachable and (b) has a referent that is not strongly reachable, the system adds that reference object to the discovered list.

The system, according to an embodiment, updates a live map based on the reached-by-data structure corresponding to the resurrected runtime object. As an example, assume that the resurrected runtime object is the referent of a reference object (e.g., a soft reference object or a weak reference object), and further assume that the resurrected runtime object becomes strongly reachable as a result of a mutator calling a get( ) method of the reference object during a termination procedure for a concurrent marking phase. In this example, the system updates a live map to mark the resurrected runtime object as strongly reachable, and, if the resurrected runtime object is not already marked as live in the live map, the system updates the live map to mark the resurrected runtime object as live. Furthermore, the system consults the reached-by-data structure to learn if any other runtime objects have become strongly reachable as a result of the resurrected runtime objects becoming strongly reachable. For any other runtime object that has become strongly reachable, the system further updates the live map to indicate the other runtime object is live and strongly reachable. In some cases, the system may mark another runtime object as live but not strongly reachable in the live map based on the reached-by-data structure. For example, if a soft reference object becomes strongly reachable as a result of the resurrected runtime object becoming strongly reachable, the system may mark other runtime objects that are softly reachable through the soft reference object as live in the live map if a discovery policy dictates that softly reachable objects should be retained in the memory area during the ongoing garbage collection cycle.

The system, according to an embodiment, updates a discovered list based on the reached-by-data structure corresponding to the resurrected runtime object. As an example, assume that the resurrected runtime object is the referent of a reference object (e.g., a soft reference object or a weak reference object), and further assume that the resurrected runtime object becomes strongly reachable as a result of a mutator calling a get( ) method of the reference object during a termination procedure for a concurrent marking phase. In this example, the reference object may or may not have been added to the discovered list during the concurrent marking phase. If the reference object is included in the discovered list, the system removes the reference object from the discovered list because the reference object's referent (i.e., the resurrected runtime object) is now strongly reachable. If (a) the resurrected runtime object is also a reference object and (b) the resurrected runtime object's referent is not strongly reachable, the system may add the resurrected runtime object to the discovered list subject to the conditions of any applicable discovery policy that is currently in effect. Further, in this example, the system surveys the reached-by-data structure for other reference objects. If the system finds another reference object in the reached-by-data structure that (a) becomes strongly reachable as a result of the resurrection and (b) has a referent that is not strongly reachable, the system adds that other reference object to the discovered list subject to the conditions of any applicable discovery policy that is currently in effect. Furthermore, having updated the live map based on the reached-by-data structure, the system may iterate through the discovered list to confirm that the reference objects in the discovered list have referents that are not strongly reachable. If the updated live map indicates that a reference object in the discovered list has a strongly reachable referent, the system removes that reference object from the discovered list. Additionally, if the updated live map indicates that a phantom reference object in the discovered list has a reachable referent, that phantom reference object is removed from the discovered list. Note that the system may iterate through the discovered list in this manner even if no resurrection occurs because during the concurrent marking phase, a reference object may have been added to the discovered list based on an incomplete understanding of reachability in the memory area. Consequently, the discovered list may include erroneous entries even if no resurrection had occurred during the termination procedure.

The system, according to an embodiment, updates the coloring of pointers based on the reached-by-data structure corresponding to the resurrected runtime object. As an example, assume that the resurrected runtime object is the referent of a reference object (e.g., a soft reference object or a weak reference object), and further assume that the resurrected runtime object becomes strongly reachable as a result of a mutator calling a get( ) method of the reference object during a termination procedure for a concurrent marking phase. In this example, the system, if need be, stores a good color to a pointer referring to the resurrected runtime object to reflect the resurrected runtime object becoming strongly reachable. Note that depending on the barrier that was imposed on the mutator, the pointer to the resurrected runtime object may have already been colored by the mutator to reflect the resurrected runtime object becoming strongly reachable. Having confirmed that the pointer to the resurrected runtime object has the appropriate coloring, the system proceeds in coloring other pointers associated with any other runtime objects whose reachability statuses have changed as a result of the resurrection. Further note that, while the reached-by-data structure was being generated during the concurrent marking phase, the system may have already colored these other pointers to reflect the other runtime objects being reachable but not strongly reachable prior to the termination procedure. However, the system further updates the coloring of these other pointers to reflect the other runtime objects now being reachable and strongly reachable.

The system, according to an embodiment, updates records of state information while at least one program instance is concurrently executing. Consequently, a program thread may attempt to access a runtime object while the system is still updating records of state information. To prevent concurrency issues, a load barrier imposed on a program thread may block access to a runtime object if that runtime object is not marked as strongly reachable at this stage of the garbage collection cycle. For instance, if a program thread is attempting to access a referent of a reference object (e.g., a soft reference object, a weak reference object, etc.) a load barrier may direct the program thread to consult a live map to determine if the referent is marked as strongly reachable. However, in some cases, a program thread may attempt to access a runtime object before a live map has been updated to reflect that runtime object having been resurrected during the termination procedure. To prevent access to a resurrected runtime object being erroneously blocked prior to the system having completing updates to a live map or another record of state information, a program thread acting in accordance with a load barrier may be made to determine if a runtime object was resurrected based on a resurrected set, reached-by-data structures and/or other records of state information. As an example, consider a referent of a weak reference object, and assume that (a) the referent was resurrected during a termination procedure and (b) the resurrection was duly recorded in a resurrected set. For the purposes of this example, further assume that a program instance is attempting to call the get( ) method of the weak reference object to access the referent prior to a live map having been updated to reflect the resurrection of the referent. In this example, a load barrier is imposed on the program thread attempting to access the referent. While acting pursuant to the load barrier in this example, the program thread determines that the referent is not marked as strongly reachable in the live map. Accordingly, the load barrier of this example instructs the program thread to consult a resurrected set and/or other records of state information to discern whether or not the referent was resurrected. In response to determining that the referent was resurrected, the load barrier imposed on the program thread permits the program thread to access the referent in this example. However, note that if the referent had not been resurrected in this example, the load barrier would have instead blocked access to the referent by returning null to the program instance.

In an embodiment, the system determines if there were any other resurrections during the termination procedure that will require further updates to records of state information, and the system proceeds to another operation based on the determination (Operation 1006). If further updates to the records of state information are required for the records of state information to accurately convey the state of runtime objects residing in the memory area (YES in Operation 1006), the system returns to Operation 1004. Alternatively, if the records of state information require no further updates to accurately reflect the state of runtime objects residing in the memory area (NO in Operation 1006), the system proceeds to Operation 1008.

In an embodiment, the system, having updated the records of state information to reflect any resurrections that occurred during a termination procedure for the concurrent marking phase, performs the remainder of the garbage collection cycle based on the updated records of state information (Operation 1008). For example, based on the updated records of state information the system may (a) process reference objects residing in the memory area during the remainder of the reference processing phase, (b) select candidate regions during a selection phase, and (c) select runtime objects residing in the candidate regions for relocation during the relocation phase. Note that if any resurrections did occur during the termination procedure, the system can perform the remainder of the garbage collection cycle in a manner that is substantially the same as the manner the garbage collection cycle would have been performed if no resurrections had occurred during the termination procedure.

### 6. Example Embodiment

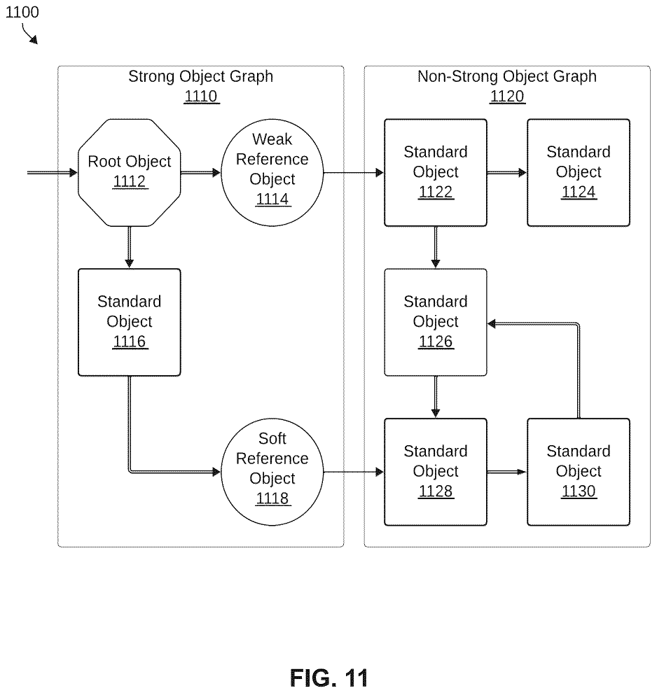

FIG. 11 illustrates an example memory area 1100 in which techniques described herein may be practiced in accordance with an example embodiment. A detailed example is described below for purposes of clarity. Components and/or operations described below should be understood as one specific example that may not be applicable to certain embodiments. Accordingly, components and/or operations described below should not be construed as limiting the scope of any of the claims. As illustrated in FIG. 11, memory area 1100 may be conceptualized as a strong object graph 1110 and a non-strong object graph 1120.

In an example embodiment, strong object graph 1110 includes runtime objects residing in memory area 1100 that are strongly reachable prior to a termination procedure for a concurrent marking phase. In particular, strong object graph 1110 includes root object 1112, weak reference object 1114, standard object 1116, and soft reference object 1118. Recall that strongly reachable objects are generally non-disposable.

In an example embodiment, non-strong object graph 1120 includes runtime objects residing in memory area 1100 that are reachable but not strongly reachable prior to a termination procedure for a concurrent marking phase. In particular, non-strong object graph 1120 includes standard object 1122, standard object 1124, standard object 1126, standard object 1128, and standard object 1130.

In an example embodiment, the system performs a concurrent marking phase in memory area 1110. State information of runtime objects residing within the strong object graph 1110 is captured by a live map, a discovered list, colored pointers, and/or other records of state information that are generated during the concurrent marking phase in memory area 1100. In contrast, state information of runtime objects residing within the non-strong object graph 1120 is captured by reached-by-data structure(s), colored pointers, a resurrected set, and/or other records of state information that are generated during the concurrent marking phase in memory area 1100.

In an example embodiment, the system, during a concurrent marking phase, encounters root object 1112 by traversing a root into memory area 1100. The system identifies the root based on a snapshot that was generated of memory area 1100 shortly before the system starting marking through runtime objects residing in memory area 1100. Upon encountering root object 1112, the system marks root object 1112 as live and strongly reachable in a live map. Root object 1112 strongly refers to weak reference object 1114, and the system traverses that strong reference to encounter weak reference object 1114. The system marks weak reference object 1114 as live and strongly reachable in the live map, and the system colors a pointer referencing weak reference object 1114 (i.e., the pointer corresponding to the strong reference that links root object 1112 to weak reference object 1114) to mark weak reference object 1114 as reachable and strongly reachable. The system finds that standard object 1122 is not marked as strongly reachable in any record of state information; therefore, the system adds weak reference object 1114 to a discovered list. The system then backtracks to root object 1112 after finding no runtime objects that are strongly reachable through weak reference object 1114. Root object 1112 strongly refers to standard object 1116, and the system traverses that strong reference to encounter standard object 1116. The system marks standard object 1116 as live and strongly reachable in the live map, and the system colors a pointer referring to standard object 1116 to mark standard object 1116 as reachable and strongly reachable. Standard object 1116 strongly refers to soft reference object 1118, and the system traverses that strong reference to encounter soft reference object 1118. The system marks soft reference object 1118 as live and strongly reachable in a live map, and the system colors a pointer referring to soft reference 1118 to mark soft reference object as reachable and strongly reachable. The system finds that standard object 1128 is not strongly marked in any record of state information; therefore, the system may add soft reference object 1118 to the discovered list subject to the conditions of any applicable discovery policy that is in effect. At this point, the system has completed marking through strong object graph 1110.

In an example embodiment, the system finds no finalizably reachable runtime objects residing in memory area 1100, and the system therefore begins marking through non-strong object graph 1120 to generate reached-by-data structures for runtime objects that could be resurrected during a termination procedure for the concurrent marking phase.

In an example embodiment, the system generates a reached-by-data structure for standard object 1122. The reached-by-data structure corresponding to standard object 1122 is generated because standard object 1122 could potentially be resurrected during a termination procedure for the concurrent marking phase. More specifically, the system generates the reached-by-data structure for standard object 1122 because (a) standard object 1122 is not strongly reachable and (b) standard object 1122 is the referent of a dereferenceable reference object that is strongly reachable (i.e., weak reference object 1114). To generate the reached-by-data structure, the system traverses the weak reference originating from weak reference object 1114 to mark through standard object 1122. Starting from standard object 1122, the system marks through runtime objects residing in non-strong object graph 1120 that are reachable through standard object 1122. At a minimum, the system marks through the runtime objects residing in non-strong object graph 1120 that are linked to standard object 1122 by chains of strong reference(s) originating from standard object 1122. In other words, the system at least marks through each runtime object that will become strongly reachable if standard object 1122 becomes strongly reachable. In the example illustrated by FIG. 11, all of the runtime objects residing in non-strong object graph 1120 are linked to standard object 1122 by a chain of strong reference(s) originating from standard object 1122. Therefore, while generating the reached-by-data structure for standard object 1122, the system marks through standard object 1124, standard object 1126, standard object 1128, and standard object 1130. Note that the system will also color pointers while marking through these runtime objects. In particular, the system will color pointers to mark these runtime objects as reachable.

In an example embodiment, the system generates a reached-by-data structure for standard object 1128 starting from soft reference object 1118. The system generates a reached-by-data structure for standard object 1128 because standard object 1128 could be resurrected during a termination procedure for the concurrent marking phase. More specifically, the system generates a reached-by-data structure for standard object 1128 because (a) standard object 1128 is not strongly reachable and (b) standard object 1128 is the referent of a dereferenceable reference object that is strongly reachable (i.e., soft reference object 1118). To generate the reached-by-data structure corresponding to standard object 1128, the system marks through runtime objects that would become strongly reachable if standard object 1128 is resurrected. Thus, in the example illustrated by FIG. 11, the system marks through standard object 1130 and standard object 1126 while generating the reached-by-data structure corresponding to standard object 1128. Note that if the system has not done so already, the system will color pointers to mark standard object 1126, standard object 1128, and standard object 1130 as reachable while generating the reached-by-data structure for standard object 1128. It should also be noted that, depending on a discovery policy that is in effect, it may not be necessary to generate a reached-by-data structure for standard object 1128. In particular, if an active discovery policy dictates that softly reachable objects are to be retained in the memory area, there may be no need to generate a reached-by-data structure corresponding to standard object 1128.

In an example embodiment, a termination procedure is initiated for a concurrent marking phase after the system completes marking through runtime objects residing in memory area 1100. During the termination procedure, a program thread calls a get( ) method of weak reference object 1114 resulting in standard object 1122 being resurrected. More specifically, calling the get( ) method of weak reference 1114 creates a new strong reference referring to standard object 1122. The new strong reference may originate from outside of memory area 1100 (e.g., a local variable), or the new strong reference may originate from a runtime object residing in memory area 1100 (e.g., weak reference object 1114). In either case, the new strong reference renders standard object 1122 strongly reachable. As a result of standard object 1122 becoming strongly reachable, standard object 1124, standard object 1126, standard object 1128, and standard object 1130 also become strongly reachable. In other words, strong object graph 1110 is expanded to further include all of the runtime objects that are depicted in FIG. 11. Prior to and/or after resurrecting standard object 1122, the program thread that causes the resurrection is made to perform collection operations stipulated by a barrier. In particular, the program thread is made to add weak reference object 1114 to a resurrected set, and/or the program thread is made to perform other collection operations. Apart from adding weak reference object 1114 to the resurrected set, the termination procedure continues normally, and the concurrent marking phase is deterministically terminated. After the concurrent reference phase is terminated, the system begins a reference processing phase. Prior to processing any reference objects during the reference processing phase, the system updates records of state information based on the reached-by-data structure that was generated for standard object 1122. In particular, the system will update a live map to mark each of standard object 1122, standard object 1124, standard object 1126, standard object 1128, and standard object 1130 as live and strongly reachable. Furthermore, the system will update colored pointers referencing theses runtime objects to mark these runtime objects as strongly reachable. Based on the reached-by-data structure, the system removes weak reference object 1114 from a discovered list because standard object 1122 is now strongly reachable. Furthermore, if soft reference object 1118 was also included in the discovered list, the system removes soft reference object 1118 from the discovered list because standard object 1128 is now strongly reachable. Having updated the records of state information based on the reached-by-data structure, the system proceeds onward with the remainder of the garbage collection cycle.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

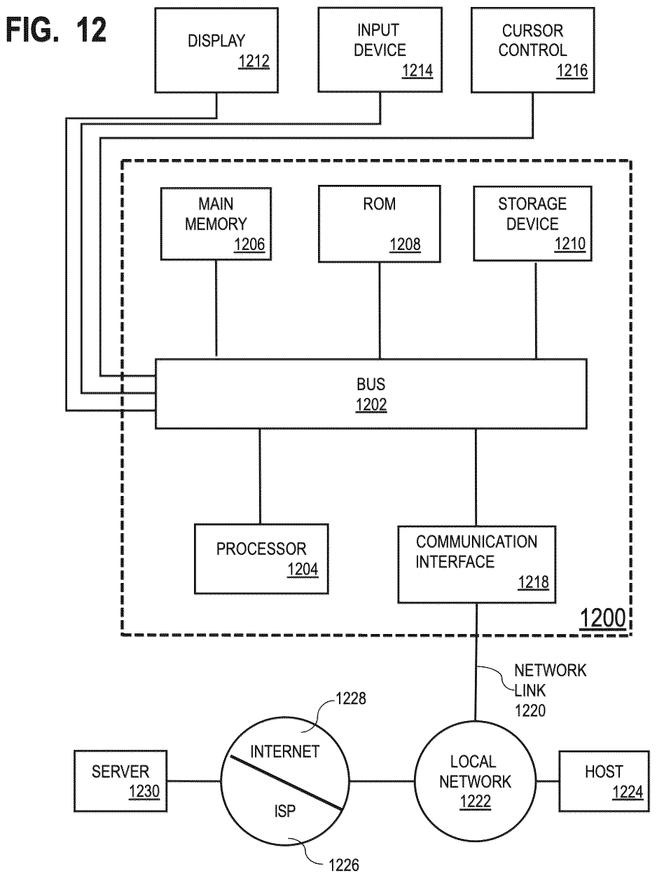

For example, FIG. 12 is a block diagram that illustrates a computer system 1200 upon which an embodiment of the disclosure may be implemented. Computer system 1200 includes a bus 1202 or other communication mechanism for communicating information, and a hardware processor 1204 coupled with bus 1202 for processing information. Hardware processor 1204 may be, for example, a general purpose microprocessor.

Computer system 1200 also includes a main memory 1206, such as a random access memory (RAM) or other dynamic storage device, coupled to bus 1202 for storing information and instructions to be executed by processor 1204. Main memory 1206 also may be used for storing temporary variables or other intermediate information during execution of instructions to be executed by processor 1204. Such instructions, when stored in non-transitory storage media accessible to processor 1204, render computer system 1200 into a special-purpose machine that is customized to perform the operations specified in the instructions.

Computer system 1200 further includes a read only memory (ROM) 1208 or other static storage device coupled to bus 1202 for storing static information and instructions for processor 1204. A storage device 1210, such as a magnetic disk or optical disk, is provided and coupled to bus 1202 for storing information and instructions.

Computer system 1200 may be coupled via bus 1202 to a display 1212, such as a cathode ray tube (CRT), for displaying information to a computer user. An input device 1214, including alphanumeric and other keys, is coupled to bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane.

Computer system 1200 may implement the techniques described herein using customized hard-wired logic, one or more ASICs or FPGAs, firmware and/or program logic which in combination with the computer system causes or programs computer system 1200 to be a special-purpose machine. According to one embodiment, the techniques herein are performed by computer system 1200 in response to processor 1204 executing one or more sequences of one or more instructions contained in main memory 1206. Such instructions may be read into main memory 1206 from another storage medium, such as storage device 1210. Execution of the sequences of instructions contained in main memory 1206 causes processor 1204 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1210. Volatile media includes dynamic memory, such as main memory 1206. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 1202. Transmission media can also take the form of acoustic or light waves, such as those generated during radio-wave and infra-red data communications.

Various forms of media may be involved in carrying one or more sequences of one or more instructions to processor 1204 for execution. For example, the instructions may initially be carried on a magnetic disk or solid state drive of a remote computer. The remote computer can load the instructions into its dynamic memory and send the instructions over a telephone line using a modem. A modem local to computer system 1200 can receive the data on the telephone line and use an infra-red transmitter to convert the data to an infra-red signal. An infra-red detector can receive the data carried in the infra-red signal and appropriate circuitry can place the data on bus 1202. Bus 1202 carries the data to main memory 1206, from which processor 1204 retrieves and executes the instructions. The instructions received by main memory 1206 may optionally be stored on storage device 1210 either before or after execution by processor 1204.

Computer system 1200 also includes a communication interface 1218 coupled to bus 1202. Communication interface 1218 provides a two-way data communication coupling to a network link 1220 that is connected to a local network 1222. For example, communication interface 1218 may be an integrated services digital network (ISDN) card, cable modem, satellite modem, or a modem to provide a data communication connection to a corresponding type of telephone line. As another example, communication interface 1218 may be a local area network (LAN) card to provide a data communication connection to a compatible LAN. Wireless links may also be implemented. In any such implementation, communication interface 1218 sends and receives electrical, electromagnetic or optical signals that carry digital data streams representing various types of information.

Network link 1220 typically provides data communication through one or more networks to other data devices. For example, network link 1220 may provide a connection through local network 1222 to a host computer 1224 or to data equipment operated by an Internet Service Provider (ISP) 1226. ISP 1226 in turn provides data communication services through the world wide packet data communication network now commonly referred to as the “Internet”1228. Local network 1222 and Internet 1228 both use electrical, electromagnetic or optical signals that carry digital data streams. The signals through the various networks and the signals on network link 1220 and through communication interface 1218, which carry the digital data to and from computer system 1200, are example forms of transmission media.

Computer system 1200 can send messages and receive data, including program code, through the network(s), network link 1220 and communication interface 1218. In the Internet example, a server 1230 might transmit a requested code for an application program through Internet 1228, ISP 1226, local network 1222 and communication interface 1218.

The received code may be executed by processor 1204 as it is received, and/or stored in storage device 1210, or other non-volatile storage for later execution.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer-readable storage media comprises instructions that, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer-readable media comprising instructions that, when executed by one or more hardware processors, cause performance of operations comprising:
executing a concurrent marking phase of a garbage collection process, wherein at least one garbage collector thread is marking runtime objects in a set of runtime objects that are concurrently being manipulated by at least one program thread that is executing a program instance;
generating, during the concurrent marking phase, a first data structure, the first data structure comprising a first set of reachability information corresponding to the set of runtime objects, the first set of reachability information indicating that a first runtime object is accessible through a first chain of one or more references originating from a root object, wherein each reference comprised within the first chain of one or more references is classified as a first reference type;
generating, during the concurrent marking phase, a second data structure, the second data structure comprising a second set of reachability information corresponding to the set of runtime objects, the second set of reachability information indicating that a second runtime object is accessible through a second chain of one or more references originating from the root object, wherein (a) the second chain of one or more references comprises at least one reference comprised within a reference object and (b) the at least one reference is classified as a second reference type;
wherein subsequent to the second data structure being generated: a program thread, while executing the program instance, resurrects the second runtime object by calling a method of the reference object; and
subsequent to the concurrent marking phase:
based, at least in part, on the second set of reachability information, updating the first set of reachability information to further reflect that the second runtime object is accessible through a third chain of one or more references, wherein each reference comprised within the third chain of one or more references is classified as the first reference type.

2. The one or more non-transitory computer-readable media of claim 1, wherein the operations further comprise:
prior to the program thread resurrecting the second runtime object during the concurrent marking phase:
initiating a termination procedure for the concurrent marking phase, wherein the program thread resurrects the second runtime object during the termination procedure for the concurrent marking phase.

3. The one or more non-transitory computer-readable media of claim 1, wherein the first reference type is a strong reference type, wherein the second reference type is a non-strong reference type, wherein a given runtime object is classified as strongly reachable if the given runtime object is accessible through a chain of one or more references of the first reference type that links the given runtime object to a given root object, wherein the second runtime object is not strongly reachable prior to the program thread resurrecting the second runtime object, wherein the second runtime object is strongly reachable subsequent to the program thread resurrecting the second runtime object, and wherein the reference object is a soft reference object, a weak reference object, a native weak reference object, or a phantom reference object.

4. The one or more non-transitory computer-readable media of claim 1, wherein calling the method of the reference object further resurrects a referent of the reference object, wherein the second runtime object is linked to the referent of the reference object by a fourth chain of one or more references originating from the referent of the reference object, wherein the third chain of one or more references comprises the fourth chain of one or more references, and wherein the second set of reachability information indicates that the second runtime object is linked to the referent of the reference object by the fourth chain of one or more references.

5. The one or more non-transitory computer-readable media of claim 1, wherein a third runtime object is linked to the second runtime object by a fourth chain of one or more references originating from the second runtime object, wherein the fourth chain of one or more references does not comprise a reference that is classified as the second reference type, wherein the fourth chain of one or more references is not comprised within the third chain of one or more references, wherein the third runtime object is resurrected as a result of the second runtime object being resurrected, wherein the second set of reachability information further indicates that the third runtime object is linked to the second runtime object by the fourth chain of one or more references, and wherein the operations further comprise: updating the first set of reachability information to further reflect the third runtime object being accessible through a fifth chain of references of the first reference type, the fifth chain of references of the first reference type comprising (a) the third chain of one or more references and (b) the fourth chain of one or more references.

6. The one or more non-transitory computer-readable media of claim 3, wherein the operations further comprise:
prior to the program thread resurrecting the second runtime object:
based, at least in part, on determining that a referent of the reference object is not marked as strongly reachable, adding the reference object to a list of one or more reference objects;
subsequent to the concurrent marking phase:
responsive to the program thread resurrecting the referent of the reference object by calling the method of the reference object, removing the reference object from the list of one or more reference objects, wherein the referent of the reference object is (a) the second runtime object or (b) a third runtime object;
based, at least in part, on the second set of reachability information, adding a second reference object to the list of one or more reference objects, wherein (a) the second reference object becomes strongly reachable as a result of the program thread calling the method of the reference object and (b) a second referent of the reference object is not strongly reachable; and
breaking a set of one more non-strong references that are respectively comprised within a set of one or more reference objects comprised within the list of one or more reference objects.

7. The one or more non-transitory computer-readable media of claim 2, wherein the operations further comprise:
generating, by the program thread during the termination procedure, an entry in a third data structure, the entry identifying the reference object that is used by the program thread to resurrect the second runtime object, wherein the second set of reachability information is identified after the concurrent marking phase based, at least in part, on the entry in the third data structure.

8. The one or more non-transitory computer-readable media of claim 7, wherein subsequent to the concurrent marking phase the operations further comprise:
prior to updating the first set of reachability information to further reflect that the second runtime object is accessible through the third chain of one or more references:
responsive to the program instance requesting to access the second runtime object:
accessing, by the at least one program thread, at least one of: (a) the first data structure, (b) the second data structure, or (c) the third data structure;
based, at least in part, on the third data structure, determining, by the at least one program thread, that the second runtime object is accessible through the third chain of one or more references; and
based, at least in part, on determining that the second runtime object is accessible through the third chain of one or more references:
accessing, by the at least one program thread while executing the program instance, the second runtime object.

9. The one or more non-transitory computer-readable media of claim 7, wherein the first data structure is a live map, wherein the second data structure is a reached-by-data structure, wherein the third data structure is a resurrected set, and wherein updating the second set of reachability information comprises marking the second runtime object as live and strongly reachable in the live map.

10. A method comprising:
executing a concurrent marking phase of a garbage collection process, wherein at least one garbage collector thread is marking runtime objects in a set of runtime objects that are concurrently being manipulated by at least one program thread that is executing a program instance;
generating, during the concurrent marking phase, a first data structure, the first data structure comprising a first set of reachability information corresponding to the set of runtime objects, the first set of reachability information indicating that a first runtime object is accessible through a first chain of one or more references originating from a root object, wherein each reference comprised within the first chain of one or more references is classified as a first reference type;
generating, during the concurrent marking phase, a second data structure, the second data structure comprising a second set of reachability information corresponding to the set of runtime objects, the second set of reachability information indicating that a second runtime object is accessible through a second chain of one or more references originating from the root object, wherein (a) the second chain of one or more references comprises at least one reference comprised within a reference object and (b) the at least one reference is classified as a second reference type;
wherein subsequent to the second data structure being generated: a program thread, while executing the program instance, resurrects the second runtime object by calling a method of the reference object; and
subsequent to the concurrent marking phase:
based, at least in part, on the second set of reachability information, updating the first set of reachability information to further reflect that the second runtime object is accessible through a third chain of one or more references, wherein each reference comprised within the third chain of one or more references is classified as the first reference type;
wherein the method is performed by at least one device including a hardware processor.

11. The method of claim 10, further comprising:
prior to the program thread resurrecting the second runtime object during the concurrent marking phase:
initiating a termination procedure for the concurrent marking phase, wherein the program thread resurrects the second runtime object during the termination procedure for the concurrent marking phase.

12. The method of claim 10, wherein the first reference type is a strong reference type, wherein the second reference type is a non-strong reference type, wherein a given runtime object is classified as strongly reachable if the given runtime object is accessible through a chain of one or more references of the first reference type that links the given runtime object to a given root object, wherein the second runtime object is not strongly reachable prior to the program thread resurrecting the second runtime object, wherein the second runtime object is strongly reachable subsequent to the program thread resurrecting the second runtime object, and wherein the reference object is a soft reference object, a weak reference object, a native weak reference object, or a phantom reference object.

13. The method of claim 10, wherein calling the method of the reference object further resurrects a referent of the reference object, wherein the second runtime object is linked to the referent of the reference object by a fourth chain of one or more references originating from the referent of the reference object, wherein the third chain of one or more references comprises the fourth chain of one or more references, and wherein the second set of reachability information indicates that the second runtime object is linked to the referent of the reference object by the fourth chain of one or more references.

14. The method claim 10, wherein a third runtime object is linked to the second runtime object by a fourth chain of one or more references originating from the second runtime object, wherein the fourth chain of one or more references does not comprise a reference that is classified as the second reference type, wherein the fourth chain of one or more references is not comprised within the third chain of one or more references, wherein the third runtime object is resurrected as a result of the second runtime object being resurrected, wherein the second set of reachability information further indicates that the third runtime object is linked to the second runtime object by the fourth chain of one or more references, and wherein the method further comprises: updating the first set of reachability information to further reflect the third runtime object being reachable through a fifth chain of references of the first reference type, the fifth chain of references of the first reference type comprising (a) the third chain of one or more references and (b) the fourth chain of one or more references.

15. The method of claim 12, further comprising:
prior to the program thread resurrecting the second runtime object:
based, at least in part, on determining that a referent of the reference object is not marked as strongly reachable, adding the reference object to a list of one or more reference objects;
subsequent to the concurrent marking phase:
responsive to the program thread resurrecting the referent of the reference object by calling the method of the reference object, removing the reference object from the list of one or more reference objects, wherein the referent of the reference object is (a) the second runtime object or (b) a third runtime object;
based, at least in part, on the second set of reachability information, adding a second reference object to the list of one or more reference objects, wherein (a) the second reference object becomes strongly reachable as a result of the program thread calling the method of the reference object and (b) a second referent of the reference object is not strongly reachable; and
breaking a set of one more non-strong references that are respectively comprised within a set of one or more reference objects comprised within the list of one or more reference objects.

16. The method of claim 11, further comprising:
generating, by the program thread during the termination procedure, an entry in a third data structure, the entry identifying the reference object that is used by the program thread to resurrect the second runtime object, wherein the second set of reachability information is identified after the concurrent marking phase based, at least in part, on the entry in the third data structure.

17. The method of claim 16, further comprising:
subsequent to the concurrent marking phase:
prior to updating the first set of reachability information to further reflect that the second runtime object is accessible through the third chain of one or more references:
responsive to the program instance requesting to access the second runtime object:
accessing, by the at least one program thread, at least one of: (a) the first data structure, (b) the second data structure, or (c) the third data structure;
based, at least in part, on the third data structure, determining, by the at least one program thread, that the second runtime object is accessible through the third chain of one or more references; and
based, at least in part, on determining that the second runtime object is accessible through the third chain of one or more references: accessing, by the at least one program thread while executing the program instance, the second runtime object.

18. A system comprising:
at least one device including a hardware processor;
the system being configured to perform operations comprising:
executing a concurrent marking phase of a garbage collection process, wherein at least one garbage collector thread is marking runtime objects in a set of runtime objects that are concurrently being manipulated by at least one program thread that is executing a program instance;
generating, during the concurrent marking phase, a first data structure, the first data structure comprising a first set of reachability information corresponding to the set of runtime objects, the first set of reachability information indicating that a first runtime object is accessible through a first chain of one or more references originating from a root object, wherein each reference comprised within the first chain of one or more references is classified as a first reference type;
generating, during the concurrent marking phase, a second data structure, the second data structure comprising a second set of reachability information corresponding to the set of runtime objects, the second set of reachability information indicating that a second runtime object is accessible through a second chain of one or more references originating from the root object, wherein (a) the second chain of one or more references comprises at least one reference comprised within a reference object and (b) the at least one reference is classified as a second reference type;
wherein subsequent to the second data structure being generated: a program thread, while executing the program instance, resurrects the second runtime object by calling a method of the reference object; and
subsequent to the concurrent marking phase:
based, at least in part, on the second set of reachability information, updating the first set of reachability information to further reflect that the second runtime object is accessible through a third chain of one or more references, wherein each reference comprised within the third chain of one or more references is classified as the first reference type.

19. The system of claim 18, wherein the operations further comprise:
prior to the program thread resurrecting the second runtime object during the concurrent marking phase:
initiating a termination procedure for the concurrent marking phase, wherein the program thread resurrects the second runtime object during the termination procedure for the concurrent marking phase.

20. The system of claim 18, wherein the first reference type is a strong reference type, wherein the second reference type is a non-strong reference type, wherein a given runtime object is classified as strongly reachable if the given runtime object is accessible through a chain of one or more references of the first reference type that links the given runtime object to a given root object, wherein the second runtime object is not strongly reachable prior to the program thread resurrecting the second runtime object, wherein the second runtime object is strongly reachable subsequent to the program thread resurrecting the second runtime object, and wherein the reference object is a soft reference object, a weak reference object, a native weak reference object, or a phantom reference object.
